(19) United States
(12) Patent Application Publication
(10) Pub. No.: US 2013/0181867 A1
(43) Pub. Date: Jul. 18, 2013

(54) Location Determination System and Method Using Array Elements for Location Tracking

(71) Applicants: Rick Sturdivant, Placentia, CA (US); Joaquin Felipe Brown, Culver City, CA (US); Chris Turner, Orange, CA (US)

(72) Inventors: Rick Sturdivant, Placentia, CA (US); Joaquin Felipe Brown, Culver City, CA (US); Chris Turner, Orange, CA (US)

(21) Appl. No.: 13/349,565

(22) Filed: Jan. 13, 2012

(51) Int. Cl. H04W 64/00; H01Q 3/00; G06Q 30/02

(52) U.S. Cl. 342/368; 705/14.58; 455/456.1

(57) ABSTRACT

A location based system is disclosed. One or more phased array modules are configured to scan to determine a signal strength indicator of a signal broadcasted from at least one wireless mobile device within a distance area. Based on a signal strength indicator measured at multiple angular directions by the one or more phased array modules from the at least one wireless mobile device, a location of each wireless mobile device is determined within a room, building, or outside location.

### PRIORITY AND RELATED APPLICATIONS

This US non-provisional utility patent application claims is co-pending with, claims priority to, and incorporates by reference in its entirety US non-provisional utility patent application entitled “SIGNAL RESET CIRCUIT FOR WIRELESS COMMUNICATION SYSTEMS” Ser. No. ______ filed herewith, and claims priority to and incorporates by reference in its entirety US non-provisional application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 filed on Dec. 4, 2011, and claims priority to and incorporates by reference in its entirety co-pending U.S. Utility patent application Ser. No. 13/010,437 filed on Jan. 20, 2011.

### FIELD OF THE SUBJECT MATTER

The field of the subject matter is broadly a dynamic wireless network and more specifically, an interactive wireless information communication and delivery system is disclosed that includes software, hardware and related methods.

### BACKGROUND

Consumers who own and use wireless two-way communication devices, such as smart phones, personal digital assistants or PDAs, hand-held devices, and other two-way communication devices, are constantly looking for new ways to use that device to interact with one's surroundings and/or receive information about their surroundings or specific items in a certain range. In addition, consumers do not want to purchase, rent or carry additional devices other than their primary device mostly based on convenience. It is this desire that has caused the dramatic increase in device applications or software “apps” that allow the user to accomplish additional tasks on a smart phone.

For example, a tourist who wants to tour a museum. The tourist will pay a fee to enter the museum, buy a guidebook and/or rent an electronic device that contains an education program on the artwork in the museum. The tourist then walks around the museum listening to the recording. The tourist must control the recording depending on where he/she is in the museum. The tourist follows a specified path, since the recording is fixed and cannot be changed based on location without rerecording the updated information.

There are conventional systems that utilize the user's smart phone in some way. For example, there are conventional systems that require the wireless-enabled device to scan for WiFi™ transceivers and many wireless-enabled devices are not available in response to the scan mode. In this instance, the wireless-enabled device is not able to detect the presence of transceivers. On the other hand, other smart phones may not be able to “know” or “comprehend” the relative position of nearby transmitters or able to correct WiFi™ protocol.

Another issue with many conventional devices is the requirement of additional hardware by the smart phone user. Solutions such as Active Bat™, for example, may require a special sound receiver and transmitter. Other WiFi™ GPS or global positioning systems solutions such as Sky Hook™ utilize standard WiFi™/GPS hardware which may provide a ten to twenty meter accuracy, and may not be very accurate for a moving or roving user in a large room with other users.

One additional piece of the puzzle is the information that is being accessed. As mentioned with the museum example outlined above, user may access a pre-taped recording organized in accordance with a specific path through the museum. Other conventional systems may require users to press a button or activate a recording at the site of each individual piece of art or interesting item. Obviously, this solution is problematic, because tourists are constantly arriving at or leaving a piece of art, and so, if someone arriving at the piece of art presses the button to activate the site recording, another arriving late will not hear it from the beginning. Some conventional solutions link to web pages.

Many conventional solutions may not track interest expressed in a particular object and/or the time spent in front of that object by each individual observer. Other conventional solutions may not allow the tourist or observer to get targeted information and/or promotional items based on the time spent in front of the artwork. For example, it would be ideal if a system were produced that sent the observer a note about a sale on Monet posters in the gift shop, if the observer spent a lot of time looking at the Monet collection. Current solutions also lack the ability to manage information in diverse formats and to allow users to record interests in specific objects.

Furthermore, there are global positioning systems (GPS) and related software that allow a user or operator to get some information about a particular location. For example, when a driver is operating an automobile with GPS, the system will show the operator what restaurants or gas stations are at the upcoming exits. While the driver may arbitrarily decide to exit and pick the first restaurant, there is no information that can be transmitted to the restaurant as to whether the driver searched for that restaurant or restaurant chain, what that driver ordered when he/she stopped, whether the driver used the drive-thru window or came inside of the restaurant, and other information that may help the restaurant or restaurant chain better market to consumers. There is a need for solutions for pushing out promotions to the prospective consumers based on their previous preferences coupled with their immediate proximity to their desired restaurant or gas station chains.

In a smaller environment, a trade show may have a hundred company booths with booth attendants who are trying to get someone to stop, chat, provide a business card and ideally, purchase what the company is selling. Trade show booths usually put out a fishbowl for business cards using a giveaway item as an enticement for the attendee to stop and talk or provide a business card. One of the new methods of getting information from attendees is for the booth workers to scan the badge of the attendee with a wireless scanner. This process results in a report being communicated to the company of additional information not usually found on a normal business card. Additional information may include what products the attendee is interested in, what journals the attendee reads, what type of business the attendee is in and other specific information provided by the attendee when registering for the tradeshow or provided to the organizing entity earlier.

There is a need for method of tracking attendees from booth to booth, whether they approach a particular booth, determining how long attendees linger at a booth, and whether they visit the booth multiple times and other information that may help the companies involved in the trade show. Consequently, there is a need in the arts for one or more systems that meet the needs and desires of both the consumer and the transmission-controlling entity, such as a museum, trade show, restaurant, sporting venue, retail outlet, theme park, hospital or any other suitable business.

Specifically, there is a need for wireless information communication and delivery systems that provide improved communication between transceivers and wireless-enabled devices based on software applications and between transceivers and wireless-enabled devices provide a wireless network that has transceivers having several modes of operation. For instance, reduced or limited interference mode that allows transceivers to establish communication with localized wireless enabled devices or a distant access mode for communication with distant wireless access points. Other needs may include for enhanced user experience including combining the configurable transceiver with a modified protocol or improved accuracy of the transmission of communication to the user as he/she moves around an environment. Still other needs including utilize the information and experiences of other users to add information and improve accuracy of the information and experience and/or utilize the information transmitted by other users to improve the information related to the distance above, below and around the observer. For example, a need for a novel system that can manage various formats of information, along with including the ability to search through the information system's history by using sophisticated and up-to-date search mechanisms and can provide promotional items or other information to a user based on the user's tracking input.

### SUMMARY

Wireless information communication and delivery systems are described herein that include at least one wireless-enabled device, a device location system, a positioning and communication system, and an information repository system.

A configurable wireless protocol device is disclosed that includes a multi-modal transceiver that can establish a communication network with a local wireless-enabled device.

A wireless network is described that includes one or more configurable wireless protocol devices, one or more wireless-enabled devices, and one or more wireless access points.

Methods of locating a wireless-enabled device are described and include providing a wireless-enabled device, providing a configurable wireless protocol device including a modified wireless-protocol, and utilizing the configurable wireless protocol device to actively scan for the wireless-enabled device.

System, apparatus, and method are disclosed that utilize a phase array module (PAM) using RF, Wi-Fi, audio-wave, e.g., Ultrasonic, to scan a room to determine location of one or more smart phones or wireless communication devices and determine location within a location or room as well as distance from one or more consumer displays.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE FIGURES AND TABLE

FIG. 1 shows a wireless information communication and delivery system.

FIG. 2 shows an advanced network development diagram.

A hardware transceiver is shown in FIG. 3.

Wireless information communication and delivery systems illustrate software-based digital data tags associated with the tagged objects and appropriate applications software be downloaded and activated on the wireless-enabled devices, as shown in FIG. 4.

FIG. 5 illustrates an embodiment with Wi-Fi AdHoc mode enabled.

FIG. 6 illustrates a hibernation/wake-up/use scenario.

FIG. 7 illustrates a communication that occurs between the smart phone, data tag, and databases.

FIG. 8 illustrates a communication methodology between Smart phone 1 and Smart phone 2 and Wi-Fi data tag.

FIG. 9 illustrates a method for distancing objects and obtaining information about specific objects in accordance with an embodiment of the present application.

FIG. 10 illustrates an exemplary system that illustrates distancing objects and obtaining information about specific objects in accordance with an embodiment of the present application.

Table I outlines exemplary messages that may be processed by wireless enabled devices, for instance, smart phones.

FIG. 11 illustrates an exemplary system using phased array modules for distancing objects and obtaining information about smart phones or other wireless communication devices within a room or location in accordance with the present application.

FIG. 12 illustrates a preferences list of a wireless communication device in accordance with the present application.

FIG. 13 illustrates a scanning diagram that illustrates power levels measured by Wi-Fi PAMs to determine wireless communication device location in accordance with the present application.

FIG. 14 illustrates a scanning diagram that illustrates distance calculations by ultrasound PAMs in accordance with the present application.

FIG. 15 illustrates a scanning diagram that illustrates power levels and distance calculations by ultrasound and Wi-Fi PAMs in accordance with the present application.

FIG. 16 illustrates phased array module with Wi-Fi or RF beam forming network for FIG. 11 in accordance with the present application.

FIG. 17 illustrates phased array module with ultrasonic transceiver modules for FIG. 11 for distancing objects and obtaining information about smart phones or other wireless communication devices within a room or location in accordance with the present application.

FIGS. 18 and 19 illustrates exemplary systems using phased array module with a Wi-Fi module, an ultrasound controller and sound transceiver units, and data tags for distancing objects and obtaining information about smart phones or other wireless communication devices within a room or location in accordance with the present application.

FIG. 20 illustrates a method for distancing objects or wireless communication devices including smart phones utilizing phased array module in accordance with the present application.

### DETAILED DESCRIPTION

Reference is now made to the drawings wherein like numerals refer to like parts throughout.

An interactive and dynamic wireless information communication and delivery system, method and apparatus has been developed and is described herein that provides, for any or all the following: communication between transceivers and wireless-enabled devices based on software applications; a communication between transceivers and wireless enabled devices without the necessity of scanning by the wireless-enabled devices. In addition, the system, method, and apparatuses developed may further be applied to a wireless network that has transceivers having several modes of operation, including but not limited to, a limited interference mode that allows transceivers to establish selectively communication with localized wireless-enabled devices or a distant access mode that allows transceivers to communicate with distant wireless access points. Furthermore, the system, method, and apparatus developed may lead to an enhanced user experience that is achieved by combining the configurable transceiver with a modified WiFi™ protocol; and improved accuracy of the transmission of communication to the user as he or she moves around, about, or within an environment. Advantageously, the system, method, and apparatus disclosed may lead to utilization of information and experiences of other users to add information and improve accuracy of the information and experience. In addition, the system, method, and apparatus may utilize information transmitted by other users to improve the information related to the distance above, below and around the observer. Also the system, method and apparatus may be utilized for other purposes such as for configurations of systems that manage various formats of information, along with including the ability to search through the information system's history by using search mechanisms and configurations that provide promotional items or other information to a user based on the user's tracking input.

As mentioned above, there are many advantages of the developed the dynamic and interactive wireless information communication and delivery systems. Other advantages, for instance, may include that the observer may generate reduced noise and/or interference by using his/her smart phone or laptop to search for information on Internet, and companies can deliver content across both traditional “face to face” and mobile application platforms simultaneously.

In one exemplary embodiment as described below, a wireless information communication and delivery system is disclosed that includes one or more wireless-enabled devices, a device location system, a positioning and communication system, and an information repository system. Many of the systems disclosed herein may be used in other contexts, which will be disclosed herein.

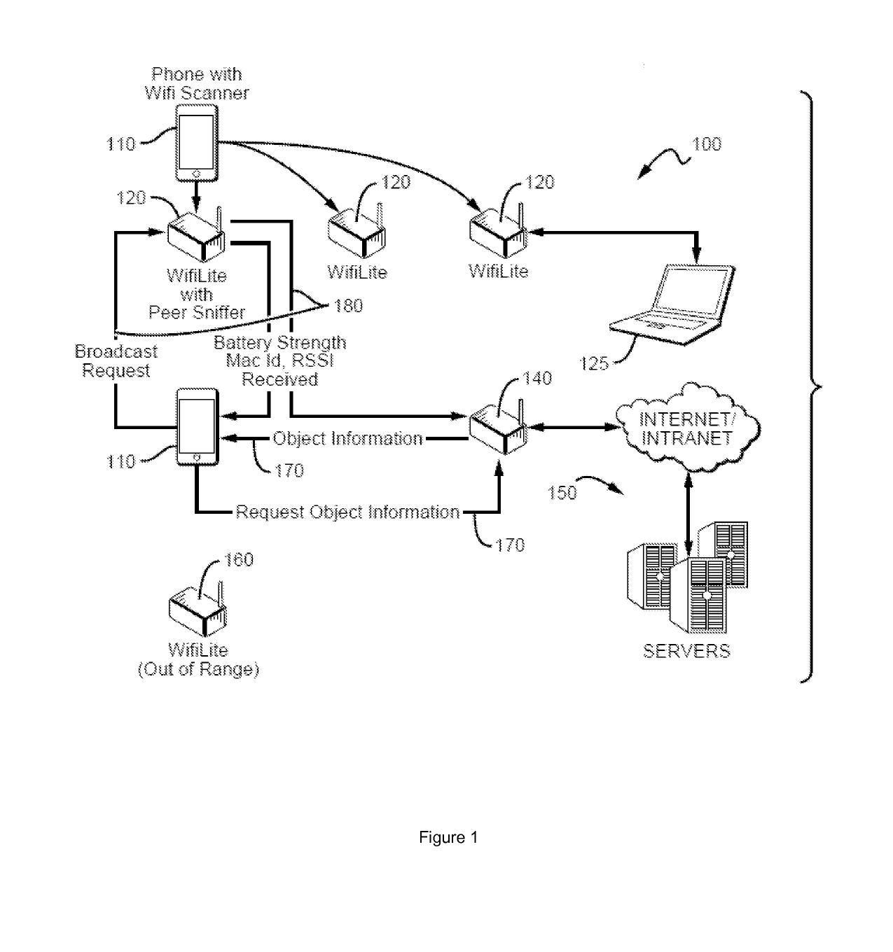

FIG. 1 shows a wireless information communication and delivery system 100 includes a wireless-enabled device 110, a device location system includes one or more transceiver 120, peer laptop 125 or combination thereof, a positioning and communication system including one or more reference point or access point 140 and an information repository system 150. FIG. 1 also shows a transceiver 160 that is out of range of the wireless information communication and delivery system. A configurable wireless protocol device is disclosed that includes a multi-modal transceiver that can establish a communication network with a local wireless-enabled device, such as a smart phone or laptop. A wireless network is described that includes one or more configurable wireless protocol device, one or more wireless-enabled device, and one or more wireless access point or a combination thereof. Wireless networks may also comprise other devices or electronics, including computers, laptop computers, hand-held and/or suitable devices.

As used herein, the term “wireless” refers to wireless communication to a device or between multiple devices. Wireless devices may be anchored to a location and/or hardwired to a power system, depending on the needs of the business, venue, event or museum. In one embodiment, wireless devices may be enabled to connect to Internet, but do not need to transfer data to and from Internet in order to communicate within the wireless information communication and delivery system.

As used herein, the term “Smart Phone” or “smart phone” refers to a wireless communication device, that includes, but not is limited to, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags from one or more information repositories, a bus line, an antenna to transmit and receive signals, and power supply such as a rechargeable battery or power storage unit.

In addition and as used herein, the term “Smart Phone” or “smart phone” refers to a wireless communication device, that includes, but not is limited to, an integrated circuit (IC), chip set, chip, system-on-a-chip including low noise amplifier, power amplifier, Application Specific Integrated Circuit (ASIC), digital integrated circuits, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags from one or more information repositories, a bus line, an antenna to transmit and receive signals, and power supply such as a rechargeable battery or power storage unit. The chip or IC may be constructed (“fabricated”) on a “die” cut from, for example, a Silicon, Sapphire, Indium Phosphide, or Gallium Arsenide wafer. The IC may be, for example, analogue or digital on a chip or hybrid combination thereof. Furthermore, digital integrated circuits may contain anything from one to thousands or millions of signal invertors, and logic gates, e.g., “and”, “or”, “nand” and “nor gates”, flipflops, multiplexors, etc., on a square area that occupies only a few millimeters. The small size of, for instance, IC's allows these circuits to provide high speed operation, low power dissipation, and reduced manufacturing cost compared with more complicated board-level integration.

As used herein, the terms “location information” refer without limitation to any set or partial set of integer, real and/or complex location data or information such as longitudinal, latitudinal, and elevational positional coordinates or relative location coordinates to one or more objects, Wi-Fi networks, and wireless communication devices.

As used herein, the terms “wireless data transfer,” “wireless tracking and location system,” “positioning system” and “wireless positioning system” refer without limitation to any wireless system that transfers data or communicates or broadcasts a message, which communication may include location coordinates or advertisements using one or more devices, e.g., wireless communication devices.

As used herein, the terms “module” or “modules” refer without limitation to any software, firmware, or actual hardware or combination thereof that has been added on, downloaded, updated, transferred or originally part of a larger computation or transceiver system that assists in or provides computational ability including, but not limited to, logic functionality to assist in or provide communication broadcasts of commands or messages, which communication may include location coordinates or advertisements between, among, or to one or more devices, e.g., wireless communication devices.

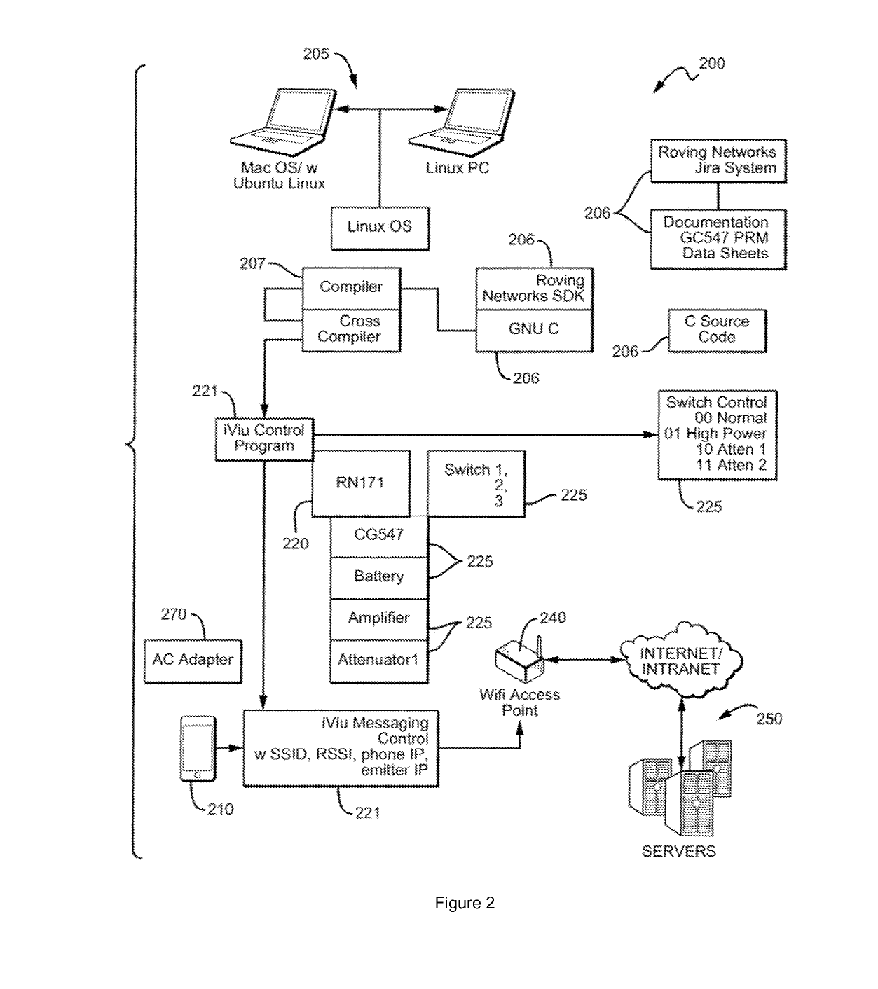

FIG. 2 shows an advanced network development diagram 200 that includes a wireless-enabled device 210, a device location system comprising at least one transceiver 220 and its components 225, a positioning and communication system comprising at least one reference point or access point 240 and an information system 250. This system shows a network system developed and compiled on a computer system 205 using various available code 206 and compilers 207. The computer system 205 is then used to load the configurable wireless protocol 221 onto the at least one transceiver 220. An AC Adaptor 270 may be provided for the system 200.

Methods of locating a wireless-enabled device are described, also shown in FIG. 1 and include: providing a wireless-enabled device 110, providing a configurable wireless protocol device 120 comprising a modified wireless-protocol (not shown); and utilizing 170 the configurable wireless protocol device to actively scan 180 for the wireless-enabled device.

As mentioned, a wireless information communication and delivery system is disclosed that includes at least one wireless-enabled device. In one embodiment, wireless-enabled devices provide for or allow two-way communication or at the very least, two-way activation. In one variant, wireless-enable devices are devices capable of utilizing WiFi™, modified WiFi™ protocol or a protocol that is similar in concept and/or function as WiFi™ protocol, such as a configurable wireless protocol. If the wireless-enabled device does not provide for or allow two-way communication, then it may be able to be located by and receive communication wirelessly from another source. Exemplary wireless enabled devices include at least one mobile phone, at least one smart phone, such as the iPhone™, Android™ or Blackberry® Torch™ at least one hand-held device, at least one laptop computer, at least one personal digital assistant or PDA, at least one ear transmitter and the like or a combination thereof.

Device location systems are also included as part of a dynamic wireless network and wireless information communication and delivery system. Device location systems comprise a transceiver or configurable wireless protocol device that may actively configure its signals to enable multiple operating modes, such as short range communication, long range communication or a combination thereof. An exemplary hardware transceiver 300 is shown in FIG. 3 that comprises an outer shell or case 310 with support nubs 315 and hardwire circuitry 320 designed to operate communications systems and related software (not shown). For example, transceivers may be miniaturized, such as the one shown in FIG. 3, which is 1 inch by 2 inches. Exemplary device location systems include a modified WiFi™ protocol that allows for location of and communication with wireless-enabled devices without the wireless enabled device having to actively scan for the transceiver.

In yet another example, a wireless protocol device includes a multimodal transceiver that established a communication network with a local wireless enabled device without first being communicated to by the wireless-enabled device. In one variant, transceivers may establish a communication network with distinct wireless access points or reference points. In another variant, transceivers include a modified wireless protocol software system, which may be modified WiFi™ protocol. In yet another embodiment, a wireless protocol device includes at least one attenuator, such as those already described herein. In one variant, attenuators define an outline a range of space within which the wireless-enabled device(s) is or are detected.

In one embodiment, radio signal strength determines the distance between a device, such as a smart phone and an object that is enabled with a data tag. The radio signal strength is the strength of the radio signal transmitted between the smart phone and the data tag. In another embodiment, the smart phone and data tag may be restricted to matching communication technologies. For example, if the smart phone contains only Wi-Fi service, the data tag may be restricted to Wi-Fi. In yet another example, if the smart phone services contain only Bluetooth, then the data tag may be restricted to Bluetooth only. On the other hand, if the smart phone has Wi-Fi and Bluetooth, the data tag could use either or both, since both the data tags and the smart phone service is implemented by the smart phone manufacturer.

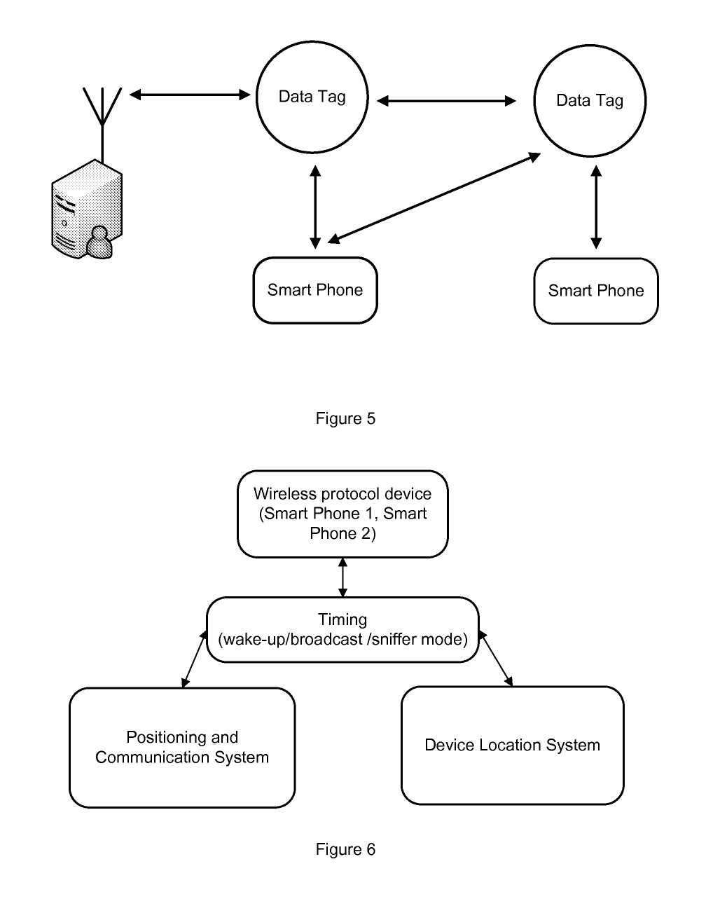

Referring to FIG. 7, a top level description of the iViu system is illustrated with several embodiments of the data tag including communication that occurs between the smart phone, data tag, and databases. Embodiment 1 is a Wi-Fi data tag solution and Embodiment 2 is a Bluetooth data tag solution. Embodiments 3-5 are other technology services that are supported by an iViu system. For example, other technology services include, but are not limited to, Near Field Communication (NFC), Radio Frequency Identification (RFID) and DASH7 and the like.

There are several methods available that are used to report or determine radio signal strength. One method is Relative Signal Strength Indicator (RSSI) which is, for example, reported during a Wi-Fi (or Bluetooth) communication transfer. In the iViu system, RSSI is used to calculate the distance to a data tag enabled object or to the nearest object. Below are described embodiments of the invention related to the use of data tags in conjunction with smart phones.

### Wi-Fi System

In this embodiment, the iViu Wi-Fi system operation includes the Wi-Fi data tag transmitting a signal, the smart phone receiving it, and then calculating RSSI. In practice, the solution and its specific implementation(s) may change depending on type, manufacturer, or operation mode of the smart phone, e.g., Android, iPhone. More particular, specifics of IViu Wi-Fi system internal operation may depend on the type, manufacture, operation mode of the smart phone. For instance, a first smart phone (Smart Phone 1) operating in a Wi-Fi scanning mode, e.g., Android, one or more data tag(s) will transmit a periodic beacon signal and the first smart phone performs a Wi-Fi scan to obtain the beacon signal from the one or more data tag(s). The first smart phone uses the received beacon signal and calculates RSSI from it. In this methodology, the reported RSSI is the signal strength of the transmission from the data tag to the first smart phone.

On the other hand, a second smart phone (Smart Phone 2), e.g., iPhone, may not be currently operating in or in a sleep mode for Wi-Fi scanning and thereby does not provide report(s) of RSSI to iViu system. In one alternative, the second smart phone may not have Wi-Fi scanning capability. Advantageously, in either of these instances, iViu system provides another method to obtain the RSSI of the signal transmitted between the data tag and the second smart phone. The method is based upon User Datagram Protocol (UDP) communication. Since UDP is not a handshaking communication method, it does not require a “connection” between the smart phone and the data tag. Therefore, the second smart phone is able to send and receive UDP communication signals between multiple data tags.

In yet another embodiment, the second smart phone sends a UDP broadcast and every data tag that is in range of the radio signal will receive the broadcast. Continuing with this embodiment, the data tags obtain the RSSI of the signal from the second smart phone; and the data tag transmit back a UDP signal to the second smart phone with the RSSI. Therefore, in this method, the RSSI is the signal strength of the signal transmitted from the second smart phone to the data tag. In one variant, the second smart phone may have Wi-Fi services occupied with communicating in UDP mode, which may preclude the second smart phone from connecting to a Wi-Fi access point for data transfer. Thus, while the second smart phone communicates in UPD mode with the data tags, it may not receive Internet traffic from a Wi-Fi access point. Thus in this variant, the second smart phone may be restricted to only receiving Internet traffic using its phone connection, such as 3 G or 4 G. We can call this the Smart Phone UDP Drawback. As such, this variant may not exist for the other embodiments, such as the Bluetooth or RFID implementation.

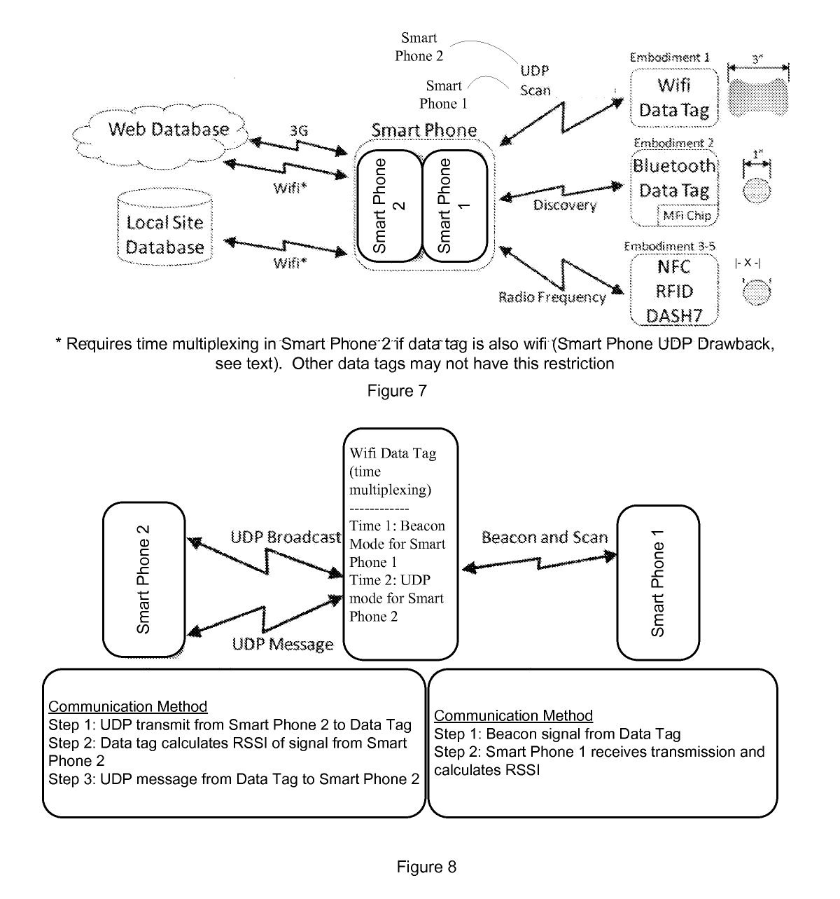

Referring to FIG. 8, a communication method is illustrated between the Smart Phone and Wi-Fi data tag. It shows the UDP messaging between the second smart phone and the Wi-Fi data tag, as well as the beacon signal from the data tag and the first smart phone. Another embodiment is the use of the data tags in a dual mode, e.g., Time Multiplexing arrangement. Continuing with this embodiment, during Time 1, the data tag operates in beacon mode for communication with the first smart phone. During Time 2, the data tag operates in UDP mode for communication with the second smart phone. By switching between communication modes at different time intervals, the data tag is able to Time Multiplex and communicates to both the first smart phone and the second smart phone.

In yet another embodiment, an implementation to the smart phone UDP Drawback is disclosed. The solution is based upon the fact that, for instance, a second smart phone may not be in a continual mode of searching for nearby objects. During operation of the iViu application or system, the user switches from a list of nearby objects to obtaining information about a specific object. During the time that the user is out of the list of nearby objects, the phone is switched from the mode of searching for nearby data tags and the phone establishes a link to the Wi-Fi infrastructure. While connected to the Wi-Fi infrastructure, the second smart phone makes a connection to Internet and the cloud database with information about objects.

Advantageously in this embodiment, while connected to the Wi-Fi infrastructure, the user performs non-data tag related activities, for instance, surfing the web, watching a video, and/or listening to audio or reading text. Once the user returns to the mode of searching for nearby data tags, the second smart phone operating system terminates the connection to the server and restarts UDP broadcasts and messaging with the data tags.

### Bluetooth Connectivity

In yet another embodiment, the smart phone obtains RSSI during the discovery process of the Bluetooth data tag. During the discovery process, the first smart phone (Smart Phone 1) may report to its operating system the RSSI of each Bluetooth device it has discovered. The first smart phone uses that information to calculate the distance to objects or the nearest object.

On the other hand, the second smart phone (Smart Phone 2) may have restricted ability to report the RSSI of discovered Bluetooth devices. Consequently, the second smart phone may require the Bluetooth transmission from the data tag to include an encrypted message that identifies the data tag as a manufacture approved product. In one variant, encryption is accomplished by attaching for instance, a special Integrated Circuit (IC), e.g. an MFI chip, to the one or more Bluetooth device.

During the Bluetooth discovery process, the IC sends an encrypted message to the Bluetooth device which is forwarded to the second smart phone. The second smart phone recognizes the encoded message and opens functionality within. Following, operation of the iViu application using the first or the second smart phone are very similar, e.g., the first or second phone uses the RSSI to determine the nearest objects and then serves up information to the user about the nearest object.

### Additional Features

In one embodiment, the iViu application and database approach and its operation are independent upon the type of data tag implemented. As additional services are added to the smart phones, the data tag will be adapted to communicate using them. Some examples of possible future services are NFC, RFID, and DASH. An exemplary device location system utilizes native TCP IP protocols to permit detection of relative distance or a specific distance range and those wireless-enabled devices within that distance range without the wireless-enabled device having to scan for the remote, configurable wireless devices. As such, the smart phone may communicate with the data tag even when type of scanning may be disabled. In one variant, one or more device location systems may be incorporated with attenuators to attenuate the signal, which enables the wireless information communication and delivery service to control the range within which the signal will be received.

As will be described in greater detail later, an exemplary configurable wireless device is disclosed of a device that is a part of the wireless information communication and delivery system and is in communication with one or more components, including the wireless-enabled device, the positioning and communication system and the information repository system. In one variant, configurable wireless devices are generally fixed position or stable. In a first instance, the configurable wireless devices may be located near or proximal to a trade show booth, a piece or work of art, or a particular retail item or store location. In a second instance, the configurable wireless devices may be located near or proximal to a ride or attraction at a theme park, an item or group of items that are inventoried or any other article, item or service that someone would be interested in learning more about at a particular time.

In yet another embodiment, some features of device location systems include that the systems comprise configurable wireless protocol or WiFi™ devices, have a modified wireless or WiFi™ protocol combinable with the configurable WiFi™ devices or transceiver. In one variant, these device location systems may be able to control “slave” or dumb devices in order to allow implementation in environments where very low cost devices are required.

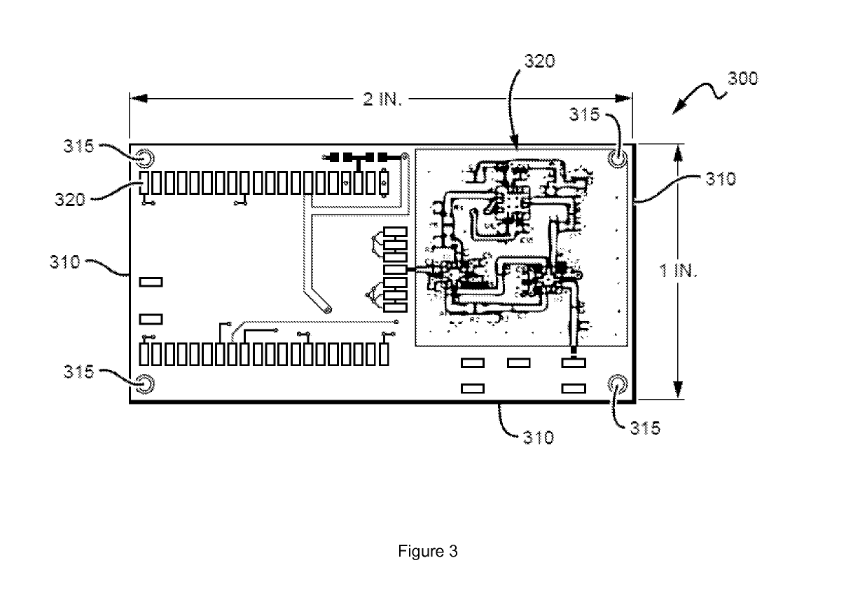

In another embodiment, such as Wi-Fi AdHoc mode shown in FIG. 5, there do not need to be any WiFi™ hubs for Internet connection, as mentioned earlier. The configurable wireless protocol device, such as a smart phone, would connect to the AdHoc network when they first arrive in the dynamic wireless network venue or space. In one embodiment, a wireless protocol device does not need to connect to Internet. In one variant of this embodiment, data is not sent to and from Internet while the wireless protocol device is in the venue or space.

In another example, AdHoc networks may provide and send messages between the device location systems, the positioning and communication systems and the wireless protocol device, e.g., one or more smart phones. In this example, because there is no Internet connection on this network, the wireless protocol device will be smart enough to maintain their cell phone carrier's Internet connection, which allows the phones to communicate with the device location systems and the positioning and communication systems via User Datagram Protocol (UDP). The Received Signal Strength Indicator or RSSI will be determined from the UDP messages, and that will indicate which wireless protocol device, e.g., one or more smart phones, the phone is near. As such, the cell phone carrier's Internet connection may be used to communicate with the information repository system to determine with which objects the device location systems and the positioning and communication systems are associated.

Other exemplary dynamic wireless networks and wireless information communication moreover, delivery systems may include a positioning and communication system. These positioning and communication systems provide a measure of accurately and more precisely locate an observer from a number of different vantage points, distance ranges and a number of different time characteristics. The time characteristics may include, for instance, how long the person stands in front of a particular exhibit or booth. Observers are detected by nearby devices and tagged objects, and the relative signal strength will be communicated to the positioning and communication system to let the dynamic wireless network know that the observer is in range of a particular tagged area, including a tagged object, booth, room or other item.

In still other embodiments, positioning and communication systems include a relative location system. These relative location systems may include at least one reference or access point that communicates with the wireless network and wireless information and communication system, along with communicating with one another. In one variant, the relative location system may collect information from the wireless-enabled device, including how long the device (user/observer) stood in a certain place or in front of a certain object (object level accuracy) and send that information to the information repository system.

Advantageously, with a position and communication system, observers not only would get a list of items, objects or locations, but also would obtain valuable additional information, for instance, whether the tagged objects are to their left, right, in front, in back, above or below them. In other words, the observers would obtain distance without any relative direction. The position and communication system uses the fact that observers are in an environment and that the observers move, giving them a different signal strength and estimated distance as they move around in the environment. If one object shows a stronger signal as observer moves, while another object fades, the system will determine that the user is moving toward the object. As larger and larger numbers of these observations of users at different points are recorded, the “perspectives” in the information system are gathered and then used to provide a “learning” method by which more and more accurate information evolves.

In another embodiments, certain “reference” points may be established using the higher power WiFi™ access points in a room that will be place or, if they are already there, will have their coordinate positions relative to a room entrance recorded. The signals from these objects will provide a base from which to calibrate the signals from the other tagged devices and objects in the room. The strength and desirability of these exemplary systems allow tagged object to be located with a level accuracy in a range of, for instance, 1 to 2 meters from the tagged object. For example, this accuracy level is possible because the exemplary wireless information communication and delivery systems use special WiFi™-based or wireless protocol-based tags that intentionally control the signal level combined with the position learning system to provide the increase object level accuracy rather than room level accuracy.

In another embodiment, a positioning and communication system that is part of a dynamic wireless network includes a relative location system. The relative location system assigns a user different or unique signal strength and estimated distance as the user moves around in a specific environment. For example, the specific environment may include a museum, a room, a trade show floor, a historic house, an automobile show, a geographic location, an amusement park, a retail location or a shopping mall.

In one variant, wireless-enabled device may use the TCP/IP broadcast/receive mechanism used in the wireless information communication and delivery systems. Other wireless-enabled device models that allow WiFi™ scanning will use scanning to get the same signals and thus reduce the amount of message traffic necessary, while at the same time save battery life on the tagged objects and related devices. Device based solution associated with a software only solution on the wireless-enabled devices provides an unprecedented level of detail for solutions without any custom hardware on the observer wireless-enabled devices. In yet another variant, wireless information communication and delivery systems may require that software-based digital data tags be associated with the tagged objects and appropriate applications software be downloaded and activated on the wireless-enabled devices as shown, for instance, in FIG. 4 and described in the Examples section.

In one embodiment, wireless information communication and delivery systems may include one or more information repository systems. The information repository systems may include a database or other storage means for storing information about the tagged objects or locations, e.g., whether they are pieces of art, rooms in a historic house, trade show booths and other tagged objects or locations. In one variant, objects and locations that are associated with a place may also be related to associated objects. In another variant, place and object relationships are additionally recursive, so that a place contained in another place may also itself contain other places. In yet another variant, the same is true for objects.

In another embodiment, information repository systems includes a database or other storage means to store information about the observers, users or customers with wireless-enabled devices that are in use with the wireless information communication and delivery system. Information about these tagged places and objects contains associated Uniform Resource Identifiers (URIs). A URI may contain a single Uniform Resource Locator (URL) if it is just a web page or the URI could itself contain various types of information such as videos, audio files, pictures, HTML pages, etc. The information can be updated on the fly or in real time, as information is generated about the item, object, event or company.

In one variant, places and objects may be tagged to both absolute (longitude and latitude) and in addition, relative (x, y, z coordinates based on an entry point) locations. The repository includes a history of movements by observers around the environment. The information repository also includes a “transactions” component that will track expressions of interest by observers in places and objects as well as their route through the places enabled for this type of wireless information communication and delivery systems. The perspectives history contained in wireless information communication and delivery systems enables the positioning functionality used by the position and communication system, which, as mentioned, records distance, signal strength and other information related to the current position of the observer.

In another embodiment, the position and communication system works in concert with the information repository system to track users within the environment, e.g., develop sophisticated demographics and analytics of the users and to push out information regarding moved tagged objects, new or recently tagged objects to the environment, or obtain new information regarding tagged objects and other valuable information. In one variant, systems may allow users to retrieve real-time information regarding objects they are viewing as well as replaying their routes and the information regarding objects that they may have bookmarked during the tour or visit.

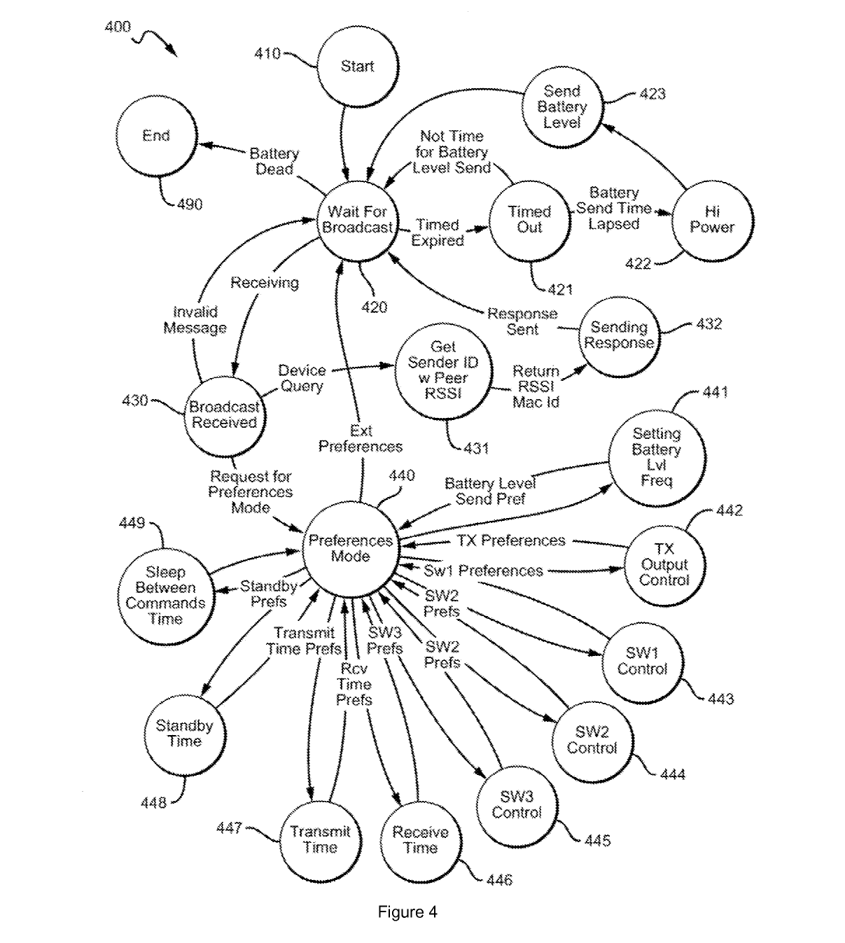

In yet another embodiment, one or more timing issues may arise between the wireless protocol device, the device location systems and the positioning and communication systems, as shown in FIG. 6. When engaged by, for instance, an appropriate app, a chosen software application or another software interface, the wireless protocol device will be in “receive mode”. The device location systems and the positioning and communication systems, however, will go into “hibernate” or “sleep mode” either manually or automatically, after a certain amount of inactivity. In this case, various methods can be used to solve any timing issues between the devices and systems.

In one embodiment, the device location systems and/or the positioning and communication systems, wake up and broadcasts a message. The wireless protocol device receives the broadcast message and determines which system it is near. At this point, there are some wireless protocol devices, such as the first smart phone, that are engaged at this point and don't need to proceed forward. However, there may be other wireless protocol devices, such as the second smart phone, that may require additional steps. In these embodiments, the wireless protocol device will send its own broadcast back to the system. The system/systems then record the IP address and RSSI for the device and returns a second message to the identified device. The systems may then enter sleep or hibernation mode for a predetermined amount of time, such as milli-seconds, seconds, minutes or hours.

### Messaging Protocol for Positioning of Smart Phone

Referring to Table I, there are outlines of messages that can be processed by wireless-enabled devices, i.e., smart phones. These messages are further described below. FIG. 4 illustrates a digital tag system 400 that may be used for a configurable transceiver. After start 410, the transceiver waits for broadcast 420 and sends or receives several messages, such as Timed Out 421, Hi Power 422, Send Battery Level 423 or Broadcast Received 430. The Broadcast Received mode 430 sends a device query 431 and sends the response 432 back to the transceiver. The Broadcast Received mode 430 will also send a request to the Preferences Mode 440, which is described below.

Continuing with this example, Messages IV00001 and IV00002 are the messages received from and sent to the phones respectively. IV00001 will be received from phones probing for signal strength and thus, proximity. An IV00001 message will contain a comma separated message that will include: IP:xxx.xxx.xxx.xxx, which is the IP of the sending, phone. These IV00001 messages will be broadcast to all devices in range so that all digital tags or OTs receiving this message can respond with their signal strength.

The phone will respond with IV00002, which will contain the device 10 of the device: Initially the MAC address of the wifi-lite or transceiver digital tag. It will also return the signal strength with which it received the IV00001 message from the phone. In one variant, the device will be placed in “Sniffer” mode so that it will see all messages on the network even though it is in “Infrastructure” mode, which would normally ignore any messages not sent to it as an access point. In this “Sniffer” mode, the OT will receive the RSSI directly from the sending phone whereas in normal Infrastructure mode the RSSI would be the RSSI from the nearest access point which would not provide the necessary positioning information to the phone. The responding message will return directly to the phone that sent it.

### Preferences Settings Mode

Because the devices may be encountered in a wide diversity of settings the need for them to operate efficiently, saving energy and thus prolonging battery life while also providing rapid response to nearby Observers, the devices will have a “Preferences” mode 440. These preferences will allow the optimization based on the following considerations: a) memory for stored messages and b) response time to requests. For example if we have 100 people moving around and requesting their position every two seconds that would be 30×100 or 3,000 messages per minute. If it slept a minute it would have a long list of messages, plus users wouldn't get answers back until they had probably moved beyond the both where the device is located. If we are fast enough we can probably get away with a 1 second sleep but because we really cannot expect to use a fixed number.

Referring to FIG. 4, Preferences Mode 440 is illustrated where various preferences are, for example, setting battery level frequency 441, TX output control 442, SW1 Control 443, SW2 Control 444, SW3 Control 445, Receive Time 446, Transmit Time 447, Standby Time 448, and Sleep Between Commands Time 449. There may be other preferences as systems are utilized and configured. Preferences Messages: Message IV10000 places the device in “Preferences Mode so that all preferences messages while in this mode will cause changes to the stored preferences. IV19999 with a “1” will cause the device to exit the preferences mode and store the changes in persistent memory. If a “0” is sent with IV19999 the DT will exit preferences mode and throwaway all changes made since entering preferences mode.

Referring to Table I, Device Tags Messaging Protocols are disclosed. The preferences mode will allow control of: Battery time before power level update. Message (Table I) IV20001. This sets the time, in minutes, between the sending of the battery level of the DTs. This is done to monitor the batteries for the need to replace them. The DTs will have to be put in high power mode so that the signal will reach the nearby access points and not just the phones within the low power range. This will be a 5 digit number from 0 to 99999 minutes. 0 indicates that the DT never sends battery information; b) Settings for switches 1, 2, 3 IV20002 sends a 3 digit number from 000 to 111. The Os and 1s indicate the on off state for switches 1, 2 and 3 by position. So, for example, value 111 would turn on all three switches while 010 would turn on switch 2 and turn switches 1 and 3 off; c) Sleep Time; and d) Variable transmit power.

Development Technology: Code will be developed using a GNU C compiler with code cross compiled to the RN171 chip using a development board. Eclipse will be used as a development IDE with the C plug in utilized. Change Control: CVS Change control will be used to provide version control and development team collaboration. Debugging: The GNU Debugger will be used for Debugging.

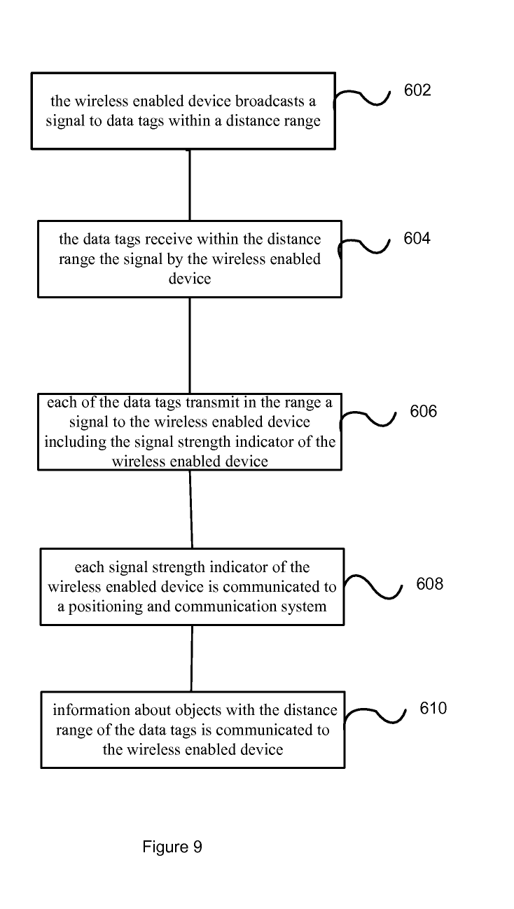

Referring to flowchart 600 of FIG. 9, a method is disclosed for calculating a distance to objects or a nearest object to a wireless enabled device using smart phone signal strength indicator, e.g., RSSI, and/or User Data Protocol (UDP) communication signals and/or data tags.

In step 602, the wireless enabled device broadcasts a signal to data tags within a distance range. In one variant of step 602, the signal by the wireless enabled device includes a User Datagram Protocol (UDP) and the signal strength indicator is computed from the UDP by each of the data tags within the distance range of the wireless enabled device. In another variant of step 602, a signal by the wireless enabled device broadcasted to data tags in the range includes broadcasting using an AdHoc network for sending messages between device locations systems, the positioning and communications system, and the wireless enabled device. In another variant of step 602, broadcasting a signal by the wireless enabled device to data tags in the range includes communicating broadcasting a signal including a WI-FI scanning signal by the wireless enabled device to the data tags.

In yet another variant of step 602, a beacon signal is transmitted by the data tags within the range of the wireless enabled device and the wireless enabled device performs a Wi-Fi scan to obtain the beacon signal and the wireless enabled device calculates the signal strength indicator in response to a received beacon signal. In yet another variant of step 602, the signal strength indicator of the wireless enabled device is attenuated to control range within which transmitting by each of the data tags in the distance range a signal to the wireless enabled device including the signal strength indicator of the wireless enabled device. In yet another variant of step 602, a beacon signal is transmitted by the data tags within the range of the wireless enabled device and the wireless enabled device performs a WiFi scan to obtain the beacon signal and the wireless enabled device calculates the signal strength indicator in response to a received beacon signal.

In step 604, the data tags receive within the distance range the signal by the wireless enabled device. In one variant of step 604, each of the data tags obtain by each of the data tags within the distance range a signal strength indicator of the wireless enabled device based on the signal from the wireless enabled device.

In step 606, each of the data tags transmit in the range a signal to the wireless enabled device including the signal strength indicator of the wireless enabled device.

In step 608, each signal strength indicator of the wireless enabled device is communicated to a positioning and communication system. In one variant of step 608, a relative location system communicates including at least one reference or access point configured to communicate with a wireless information and communication network and to collect information about the wireless enabled device. In another variant of step 608, the information about the wireless enabled device includes how long a user stood in a certain place or in front of a certain object and send information to an information repository that includes a transaction component that tracks expressions of interest of observers in places and objects as well as a route of the observers through the places. In another variant of step 608, each signal strength indicator is communicated of the wireless enabled device includes each of the data tags communicate with a dynamic wireless network each signal strength indicator that indicates which data tags or tagged objects are included within the dynamic wireless network.

In yet another variant of step 608, each signal strength indicator is communicated of the wireless enabled device includes the wireless enabled device communicates with a dynamic wireless network each signal strength indicator that indicates which data tags or tagged objects that are part of the dynamic wireless network. In another variant of step 608, each signal strength indicator of the wireless enabled device communicated to a positioning and communication system includes a relative location system that communicates each signal strength indicator to a WI-FI network to communicate location based on relative signal strength within an information repository which objects a device location system and the positioning and communications system are associated.

In step 610, information about objects with the distance range of the data tags is communicated to the wireless enabled device.

Continuing with the embodiment, the system includes data tags configured to receive a signal transmitted by at least one wireless enabled device within the distance range. In one variant, each of the data tags obtains within the distance range a signal strength indicator from the signal transmitted from each of the wireless enabled device; and in response, each of the data tags transmits within the distance range a signal to the wireless enabled device including the signal strength indicator of each of the at least one wireless enabled device. In one variant, the system may include a positioning and communication system configured to communicate with each of the data tags within the distance range and receive at least one signal strength indicator of each of the at least one wireless enabled device and communicate with each of the at least one wireless enabled device to deliver information about objects with the distance range of the data tags.

Furthermore, the signal transmitted by the wireless enabled device includes a User Datagram Protocol (UDP) and the signal strength indicator is computed from the UDP by each of the data tags in the distance range of each of the at least one wireless enabled device. In yet another variant, a relative location system may be utilized that includes at least one reference or access point configured to communicate with a wireless information and communication network and to collect information about each of the at least one wireless enabled device within the distance range. In another variant, the information about the wireless enabled device includes how long a user stood in a certain place or in front of a certain object and send information to an information repository that includes a transaction component that tracks expressions of interest of observers in places and objects as well as a route of the observers through the places.

In yet another embodiment, each signal strength indicator of the wireless enabled device communicate to each of the data tags and communicate with a dynamic wireless network each signal strength indicator that indicates which data tags or tagged objects to a dynamic wireless network. In still another embodiment of this system, communicating each signal strength indicator of the wireless enabled device includes the wireless enabled device communicates with a dynamic wireless network each signal strength indicator that indicates which data tags or tagged objects that are part of a dynamic wireless network. In another embodiment of the system, an Adhoc network configured to send messages between device locations systems, the positioning and communications system, and the wireless enabled device.

In still another embodiment, a relative location system may communicate with the positioning and communication system communicating each signal strength indicator of the wireless enabled device to a positioning and communication system having a relative location system includes communicating each signal strength indicator to a Wi-Fi network to communicate location based on relative signal strength within an information repository from which objects a device location system and the positioning and communications system are associated. The system may further include the wireless enabled device broadcasting a signal to data tags in the range comprises communicating broadcasting a signal including a Wi-Fi scanning signal by the wireless enabled device to the data tags. The system may further include attenuating the signal strength indicator of the wireless enabled device to control range within which by each of the data tags in the range transmit a signal to the wireless enabled device including the signal strength indicator of the wireless enabled device. In yet another variant, transmitting a beacon signal by the data tags within the range of the wireless enabled device and the wireless enabled device performs a Wi-Fi scan to obtain the beacon signal and calculates the Signal Strength Indicator in response to a received beacon signal.

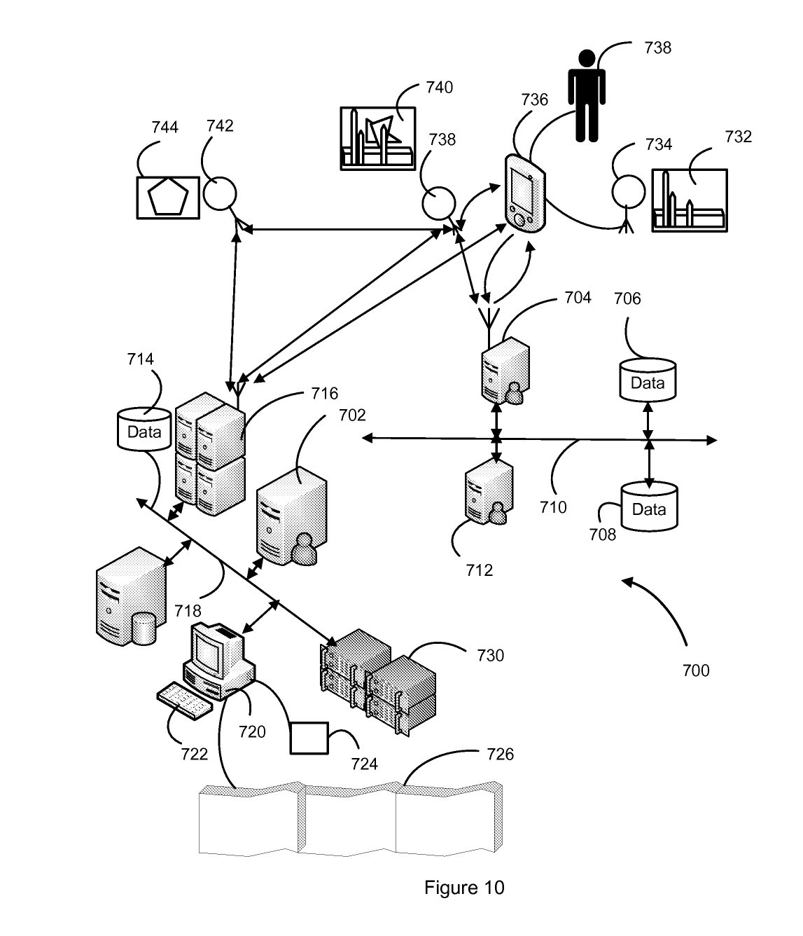

Referring to FIG. 10, system 700 is disclosed that measures relative signal strength, e.g., RSSI, of a wireless enabled device that broadcasts a signal within a distance range of objects that are associated with data tags as illustrated in FIGS. 1-9, Table I and associated text. For instance, system 700 communicates, for instance, using communications server 716 by wired bus 718 or wireless means, such as Bluetooth or Wi-Fi, connectivity with private and public databases, though communications server 704, 712 having wireless capability to access, for instance, information repository 706, 708 coupled to bus 710 and extracts information, e.g., RSSI, from a nearby smart phone 736, for instance, Smart Phone 1 and Smart Phone 2 illustrated in FIGS. 1-9 and associated text or in Table I.

System 700 further includes data storage hardware device 714 capable of storage of user data, e.g., preferences, interests, “perspectives” in the information system, relative coordinates of smart phone 736 and/or user 738 using the smart phone 736 to an object, e.g., painting 744, 740, 732, or Wi-Fi device or data tags 742, 738, 734 associated with or closest to the object. For example, a particular item or location, e.g., as well as other information, for instance, relative location or distance from one or more of data tags 742, 738, 734 that are referenced, for instance, to an object 744, 738, 732 respectively or other components disclosed in FIGS. 1-9 and Table I on a temporary, transitory, or permanent basis. Application server 702 stores executable software program code, for instance, RSSI signal strength calculation or User Datagram Protocol (UDP) algorithms in a semi-transitory or non-transitory software media capable of transferability using communications server 716 to transmit wired or wirelessly from processor unit 724, for example, communicatively coupled to computer 720 that has a keyboard 702 to allow, for instance, user 738 to provide remote inputs or direct inputs (if user is within range of keyboard 722).

Continuing with this embodiment, system 700 may store executable software program code in application server 702 in one or more tangible forms, for example, communicatively coupled to memory 726 (which may be ram, flash, or flash drive) or persistent storage 730 such as a hard drive or rewritable hard-disk external (that may be fixed or removable) communicatively coupled to computer 720, for instance, through bus line, e.g., bus line 718.

In one embodiment, communications server 716 transmits wirelessly to another network, e.g., radio towers, cell-phone towers, communication satellites, or the like, to access files stored in databases 706, 708 (e.g., private databases). In one variant, the databases 706, 708 are one or more information repositories accessible through communication servers 704, 712 and coupled wirelessly, e.g., using data tags 742, 738, or 734 or smart phone 736 or wired, for instance, to bus line, e.g., bus lines 718, 710. In another variant, communications server 704 transmits wirelessly to another network, e.g., radio towers, cell-phone towers, communication satellites, or the like to access files or documents stored in database 714, for instance, accessible through bus line, e.g., bus line 718. In yet another example, system 700 may be stored in memory in a consumer apparatus or smart phone 736 (e.g., a hand-held computer with plug in serial, parallel, or usb adaptor compatibility) through bus line 710, 718 or wirelessly coupled using a local network, e.g., wireless servers 716, 704, 712 or through cell phone towers, communication satellites to access, for instance, one or more databases 714, 706, 708 for accessing sets of consumer data processing by system 700.

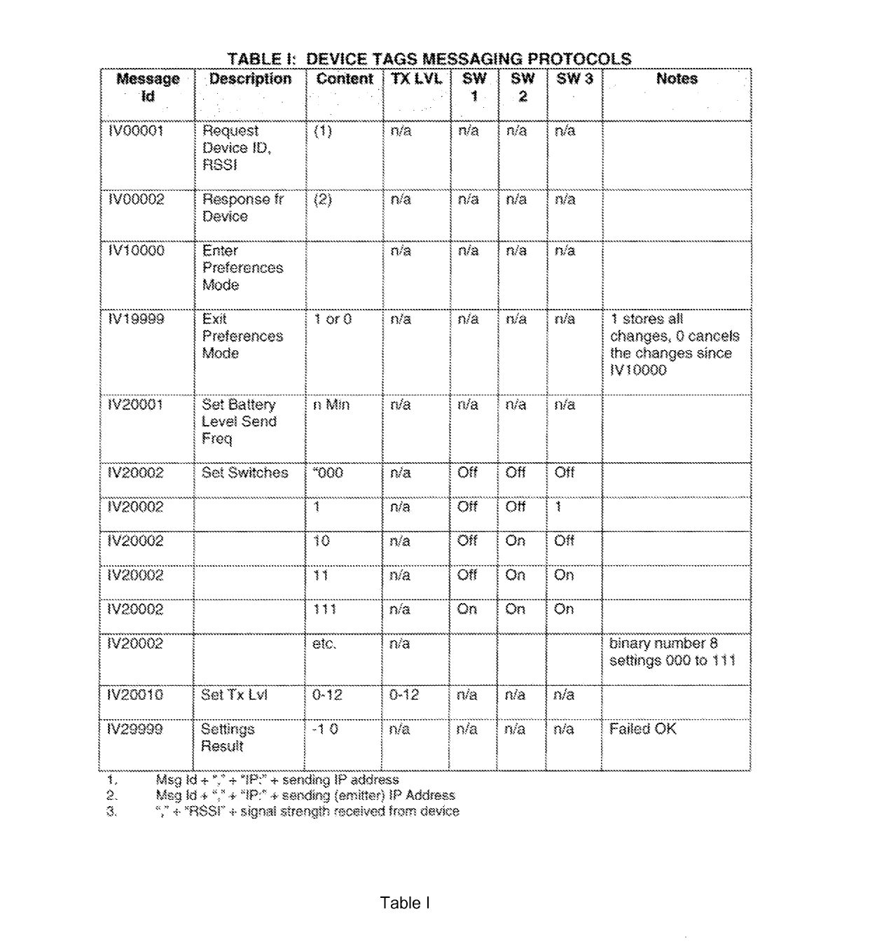

Referring to FIG. 11, a location based system 800 is disclosed. System 800 includes one or more phased array modules 802, 804, 806, 807 configured to scan to determine a signal strength indicator, e.g., RSSI, of a signal broadcasted from wireless mobile devices 828, 830, e.g., Smart Phone 1, Smart Phone 2, or other wireless communication device within a distance. Based on a signal strength indicator measured at multiple angular directions by the one or more phased array modules 802, 804, 806, 807 from wireless mobile device, e.g., smart phone 828, 830, a location of wireless mobile device, e.g., smart phone 828, 830 is determined within a room, building, or outside location. In one embodiment, one or more phased array modules 802, 804, 806, 807 are configured to scan an area includes to scan an area using at least one of the following: audio signals, e.g., ultrasound waves, radio waves, or Wi-Fi signals.

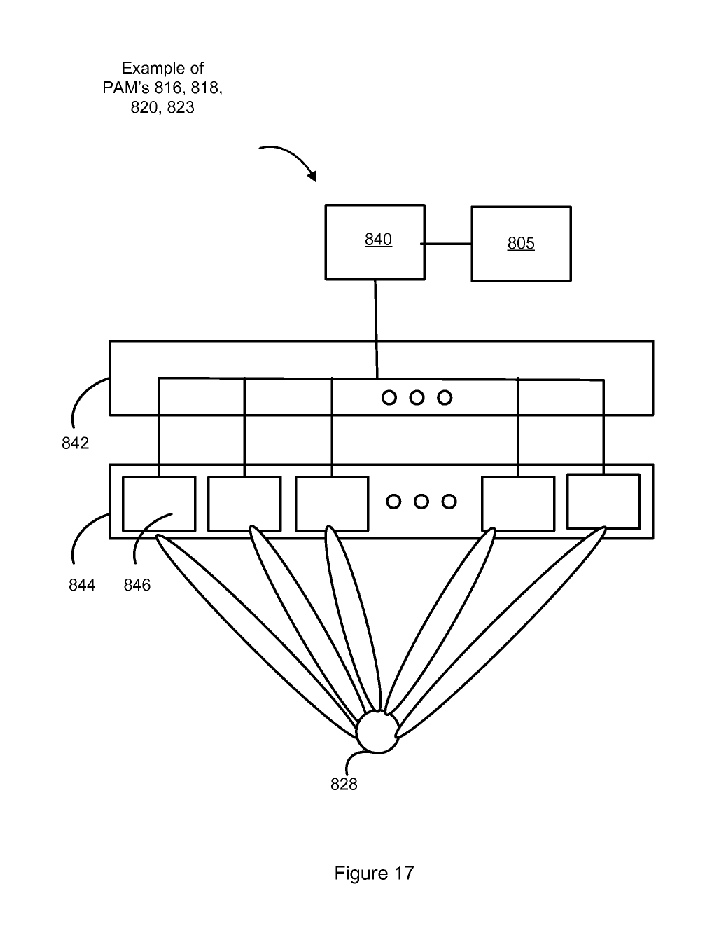

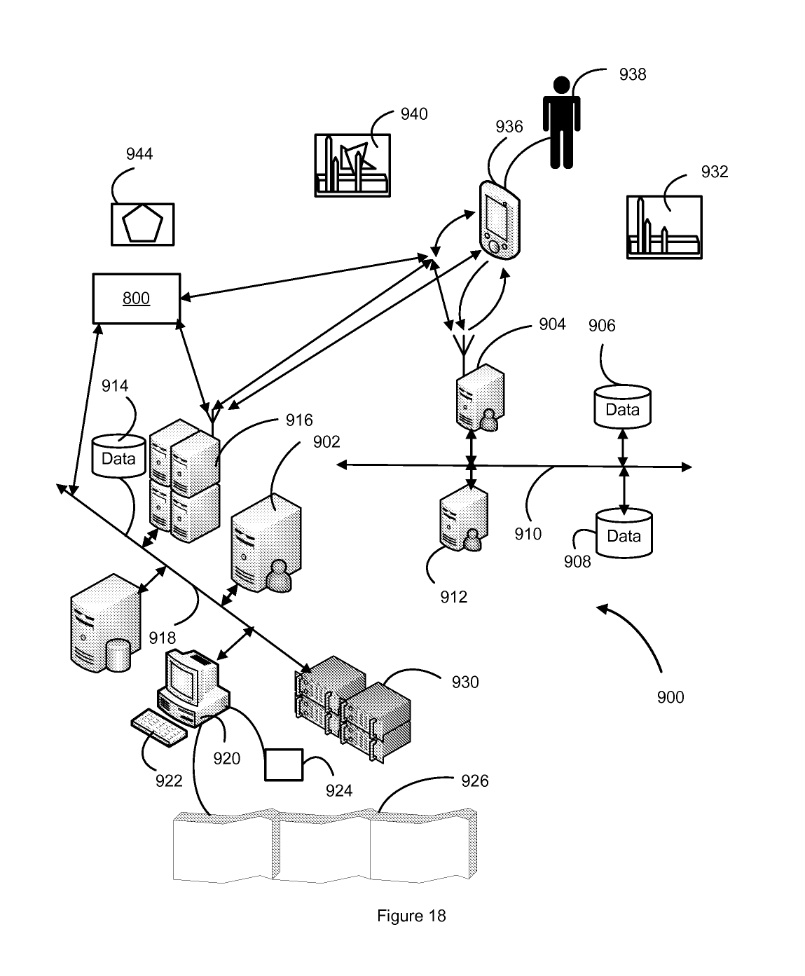

In one embodiment, software is downloaded, upon user consent, on one or more wireless mobile devices, e.g., smart phone 828, 830, to process at least one of the following: radio frequency (RF) signal, audio signals, e.g., ultrasound waves, radio waves, or Wi-Fi signals, by the wireless mobile device, e.g., smart phone 828, 830. Continuing with the embodiment, the wireless mobile device may process the incoming signals or waves and, in response, broadcast a modified or adjusted signal to conform to request from one or more PAMs. In one variant, one or more phased array modules (PAMs) 802, 804, 806, 807 include Wi-Fi module 808 (shown in FIG. 16) or an ultrasound controller 840 (shown in FIG. 17).

As such, Phased Array Modules (PAMs) electrically or mechanically scan a room, building, area, or outdoor area to determine at each angle a signal level, e.g., detectable, significant, maximum, received from or transmitted to a Receiving/Transmitting (RT) device. Using an angle of maximum signal level and several PAMs, location to the RT device, e.g., may be determined. The RT device, as an example, can be a mobile smart phone, e.g., smart phone 828, 830.

Referring again to FIG. 11, an application in a room with four PAMs (802, 804, 806, 807) and two RT devices (828, 830) are illustrated. In one example, one or more PAM(s) emit(s) directional signal(s) that form a narrow signal beam by one or more antenna arrays onto smart phones, e.g., smart phone 828, 830. The narrow signal beam is scanned over an angular range. For each angle, the PAM records the signal strength indicator, e.g., RSSI, from one or more smart phone. The angle/signal strength information is used to calculate, for instance, through triangulation of multiple measurements, the location of one or more RT devices.

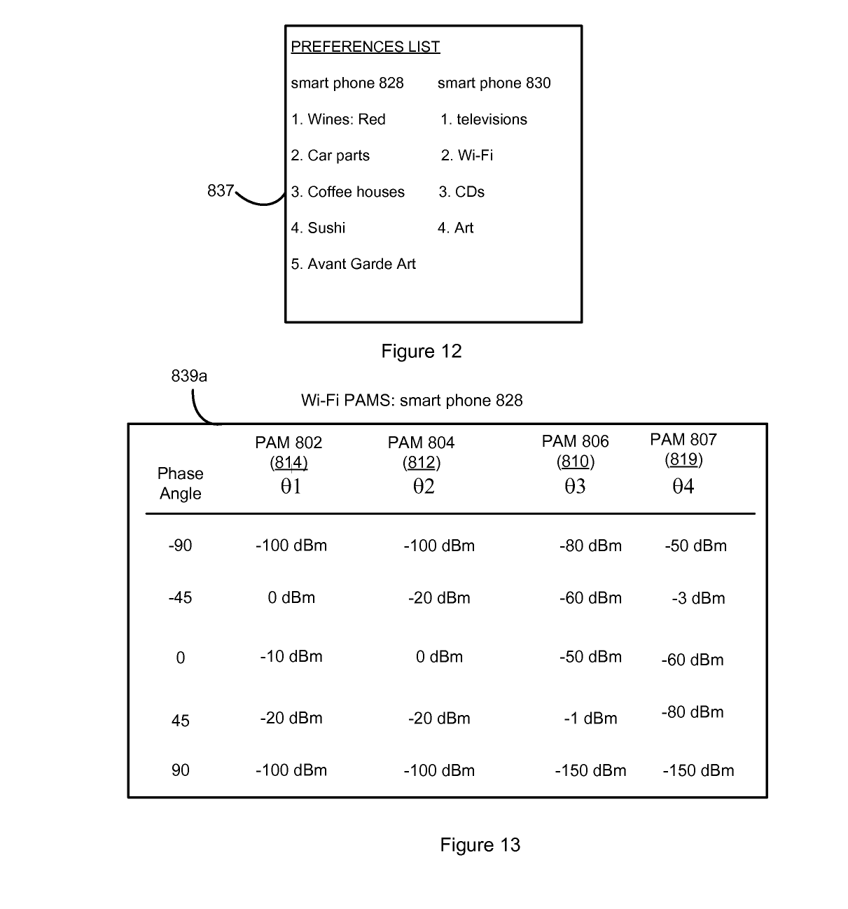

In one example, the PAM may be a radio wave based phased array element or have audio phased array elements. As illustrated in FIG. 13, PAM generates on a per phase angular basis relative signal strength indicator for one or more receiving/transmitting devices within its signal range. In this example, a highly directive signal beam scans electronically or mechanically at an angle from −90 degrees to +90 degrees for each of the PAMs. In one variant, the PAM may be centrally located so that the scanning angle ranges from 0 to 360 degrees. For example, for the radio wave realization, the system may use, among other possible radio wave signals, Wi-Fi, and/or additional or other signals, for instance, based upon the appropriate FCC 802.11 regulations. In this example, the signals used are modified in a unique way, by using beam forming and beam steering electronics, e.g., as illustrated in FIGS. 16 and 17, to create highly directive and steerable signal beams.

In the exemplary embodiment disclosed in FIG. 11, PAMS 802, 804, 806, 807 are located at edges of room and scan between −90 to 90 degrees. As illustrated in FIG. 13, at each scanned angle, the PAM records the signal strength, for example, of smart phone 828, 830, which is receiving/transmitting device. As illustrated in FIG. 13 from smart phone 828, PAM 802 (812) scans at −45 degrees and receives a maximum signal level of 0 dBm, PAM 804 (812) scans at 0 degrees and receives a maximum signal level of 0 dBm, PAM 806 (810) scans at +45 degrees and receives a maximum signal level of −1 dBm, and PAM 807 (819) scans at −45 degrees and receives a maximum signal level of −3 dBm. Values for other exemplary angular values are indicated in FIG. 13. The resulting table of angles (θ1, θ2, θ3, θ4) and signal strength are used by the PAM or a separate unit to triangulate the location of the receiving/transmitting devices. By comparing, e.g., triangulating angular locations (θ1, θ2, θ3, θ4) maximum signal strength, e.g., indicated for instance in dBm, a location of smart phone, e.g., smart phone 828, may be determined in a location or room, e.g., an indoor location. Based on determined location in room, preferences list 837, e.g., remotely located, may be accessed by one or more PAMS 802, 804, 806, and 807, e.g., either directly or by permission using smart phone 828.

Advantageously, directed advertisements e.g., from advertisement modules 824, 826, based on preferences, current and/or predicted location of the smart phone 828 are pushed, e.g., texted or emailed, to the smart phone 828. In this example, advertisement of a first consumer product display, e.g., coffee display 833, may be pushed to smart phone 828, for instance, by advertisement modules 824, 826 based on preferences list 837 associated with smart phone 828 of a user, e.g., coffee houses. In yet another example, directed advertisements based on preferences, current and/or predicted location are pushed, e.g., may be texted, emailed, or sent, to the smart phone 830, for instance, based on current location, a second consumer product display, e.g., plasma screen televisions 831.

Referring to FIG. 16, the PAM, e.g., PAM 810, 812, 814, and/or 819 includes Wi-Fi module 808 having firmware or software programmed for beam forming functionality. More specifically, the disclosed PAM includes a Beam Forming Section (BFS) 832. The BFS 823 may be realized using Wilkinson power dividers, couplers or other signal splitting methodology. The PAM contains a Beam Steering Section (BSS) 834. The BSS 834 includes phase shifters 835 which apply a progressive phase shift forming a highly directive signal beam scanned over the angle θ1, θ2, θ3, θ4, where each angle is a summation, for instance, of individual phi angles, e.g., φ1, φ2, φ3, φ4 from BSS 834. The PAM, e.g., PAM 810, 812, 814, and/or 819 includes an array of antennas 836 (individual antennas 838) which can be realized as microstrip patch antennas or other antenna topology having one or more tunable or directional elements.

Wi-Fi module 808 firmware provides software coding to communicate with, e.g., scan, evaluate, and/or manipulate, signals received or transmitted from wireless communication device(s) 828, 830, e.g., Smart Phone 1 (e.g., Iphone) and Smart Phone 2 (e.g., Android). In one embodiment, Wi-Fi module 808 firmware includes software coding, e.g., Wi-Fi reset coding, incorporated by reference patent applications. As such, the firmware includes software code to allow for achieving the desired functionality required by the PAM. In one embodiment, the firmware controls the phase shifters, creates and stores received power level in accordance with angle signal strength table and calculates the triangulation to the RT within range of the PAM.

Furthermore, the PAM may contain a firmware or hardware reset circuit, e.g., Wi-Fi reset circuit 805, disclosed in the co-pending application above incorporated by reference in its entirety and claimed priority to.

In one embodiment, a Triangulation Computation Device (TCD) may use measurements from one or multiple PAMs 810, 812, 814, 819 for triangulation calculations. In yet another embodiment, a separate unit may calculate the triangulation of each of the RT elements within range of PAMs. In this case, the TCD may be firmware within one or more PAMS (or external thereto) or coupled or connected, for instance, by bus line 847 or coupled, e.g., wirelessly, between and among each of the PAMs or the PAMs may communicate wirelessly to the TCD to send the angle and signal strength information. The TCD, then sends the location information to the RT devices or uses one or multiple PAMs 810, 812, 814, 819 to send distance range, relative distance, specific distance range, route, location information, intermediate destination, or predicted or actual location information to one or more RT devices.

In yet another alternative, Received/Transmit (RT) Devices may be transmitting electronic devices or receiving electronic devices or may contain both receiving and transmitting electronics. If RT devices are just receiving electronic devices, then the RT elements receive signals from the PAMs which contain angle information and the RT then generates the table of angle and signal strength, e.g., FIGS. 13-15, and calculates location using triangulation. In one alternative, if the devices are purely transmitting electronic devices, then the RT transmits signals and the PAMs receive them and do their required computations to determine location, e.g., FIGS. 13-15. In another alternative, if the electronic devices are both receiving and transmitting devices such as a smart phone, the RT transmits signals and PAM receives them. The PAM or TCD calculate the triangulated location of the RT transmits and receives the location information, e.g., 839a-c, to and from the RT device. In another embodiment, the RT device uses its location information to access location based information, e.g., from advertisement modules 824, 826, using information, for instance, from cloud server 845, using mobile phone service, Wi-Fi or other communication protocol that can deliver information to the RT.

Turning to FIG. 11, advertisement modules 824, 826 may be configured to access a preferences list 837 for a wireless mobile device, e.g., smart phone 828, 830, and to direct advertisements 824, 826 based on location, relative distance, route, or location information of wireless mobile device, e.g., smart phone 828, 830. In one variant, advertisement modules 824, 826 may be configured to direct advertisements based on the location of the wireless mobile device, smart phone 828, 830. As illustrated in FIG. 11, beam steering routine, e.g., using 810, 812, 814, 819 PAMs, forms and steers a highly directive signal beam communicated between the one or more phased array modules 802, 804, 806, 807 through one or more directional antennas 838. The PAMS generate a listing of a group of wireless mobile devices, e.g., smart phones 828, 830, having a directional pattern, route, relative distance within a designated period or time and at least partially based on relative distance from one or more consumer product displays 831, 833, or data tags 839, 840. In one example, data tags 839, 840 may individually receive and transmit signal strength indicator and UDPs using principles illustrated in FIGS. 1-9 and accompanying text, with the room, the building, or outside location 835.

As illustrated in FIG. 11, advertisement modules 824, 826 may be configured to direct advertisements to a designated groupings of wireless mobile devices, wireless mobile devices, e.g., smart phones 828, 830, in one or more locations. FIG. 17 includes an exemplary block diagram of PAMs 816, 818, 820, 823 with an ultrasound controller 840 having a power divider 842 and multiple ultrasound transceivers 844 (including individual ultrasound transceiver 846) to perform signal scanning for specific or generalized broadcast signals from one or more smart phones 828, 830.

Referring to FIGS. 11 and 17, the RT devices are ultrasound devices and either receive, transmit or both receive and transmit ultrasound signals. One example of an ultrasound RT device is a mobile smart phone that receives the ultrasound signals, which are transmitted at a frequency, which may be just above the audible range for humans but below the cut off range for the phone. In one example, smart phone, e.g., smart phone 828, is a receive element that receives the audio signals with phase information from each of the PAMs. The phone calculates its position using triangulation. There are many other possible realizations using smart phones and ultrasound transceivers and receivers. For instance, smart phone 828 may transmit an ultrasound signal and the PAMs receive them and perform calculations, e.g., using firmware or software, for triangulation then transmit signaling information, e.g., signal strength or location information, back to smart phone 828 or to cloud server 845.

In one embodiment, Ultrasound Based PAMs, e.g., PAMS 816, 818, 820, 823, create an ultrasound beam using transducers 844, which convert the electrical signal into a sound waves. The phase at each transducer 846 is controlled by Phase Computation Electronics 842. Phase Computation Electronics 842 calculates the relative phase at each transducer (e.g., transducer 846) and sends the appropriate phase to one or more smart phones. A return sound wave is received from the one or more smart phones and cross-referenced with device identification, for instance, code sent with broadcasted signal and/or UDP signal, for one or more wireless communication devices, e.g., smart phones 828, 830, including amplitude signal strength indicator, e.g., RSSI, associated with wireless communication device, e.g., smart phone 828, smart phone 830. Phase shift of return sound signal is compared to the originated signal to determine a time delay. The time delay and the velocity of sound wave, e.g., indoors at 20 degrees C. the velocity of sound wave is 340 m/sec, together determine location of one or more PAMs from a wireless communication device.

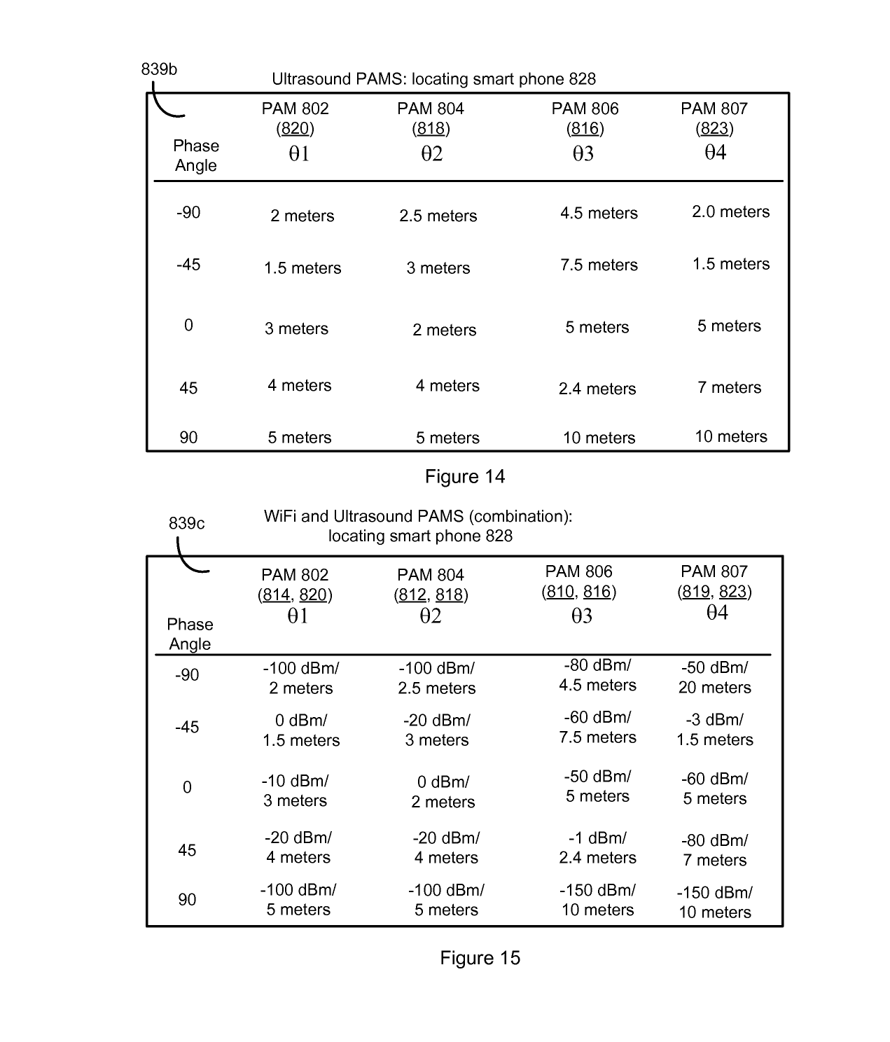

Referring to FIG. 14 from smart phone 828, PAM 820 scans at −45 degrees creates a return signal having a time delay equivalent at room temperature to 1.5 meters, PAM 818 scans at 0 degrees and receives a return signal having a time delay equivalent at room temperature to 2 meters, PAM 816 at scan at +45 degrees and receives a return signal having a time delay equivalent at room temperature to 2.4 meters, and PAM 823 scans at −45 degrees and receives a return signal having a time delay equivalent at room temperature to 1.5 meters. In one variant, a rate of change of location of the wireless communication device may be tracked, e.g., by one or more PAMS, to compute a velocity, rate of movement, of one or more wireless communication devices, e.g., smart phone 828, 830, within a room or location. Continuing with this variant, velocity would be computed based on relative distance or distance change, e.g., delta distance, at a function of time, e.g., delta time change, between sweep angle measurements.

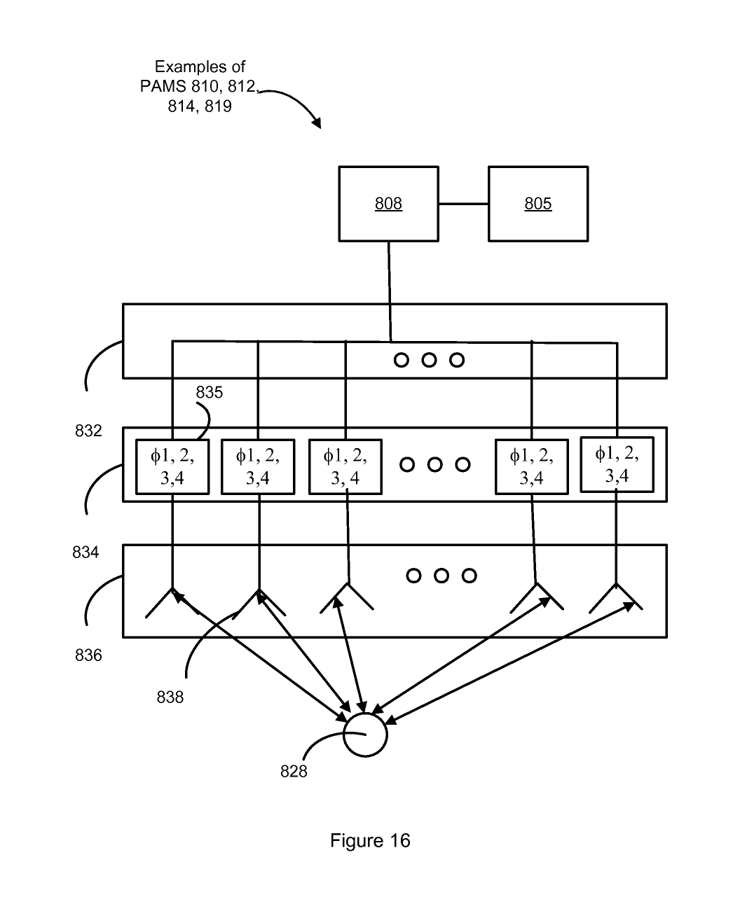

As illustrated in FIGS. 14 and 15, outputted scanning ultrasound signal are transmitted from multiple ultrasound PAMs to one or more wireless communication devices. Returned signal including device identification code, e.g., User Datagram Protocol (UDP), algorithms are sent to one or more comparators, e.g., firmware or hardware implementations that provide signal comparison functionality. Return signal time delay, e.g., delta time, are utilized with velocity of sound wave to determine location for wireless communication devices, e.g., smart phones, for example, in room or location to determine relative distance.

As such, multiple ultrasound PAMs indicate presence and/or location of wireless communication devices, e.g., smart phones, in the room without the need for GPS devices or direct line of sight to a GPS signal. In one variant, by staggering position of ultrasound PAMs, e.g., one or more physically separate or scanning angle separate units, obtain in a real-time location mapping of wireless communication devices in a room or location. Advantageously, even if one or more wireless communication devices are blocked from receiving one or more ultrasound PAMs waves, it is still possible to receive location information, route, or relative distance for these devices from available, unblocked, ultrasound PAMs. Furthermore, by having multiple ultrasound PAMs waves, one can pick or choose PAMs location measurements based on receipt of, for example, one or more that have one or more reliability indications, such as quality, error-free, retransmission (return path).

For example, signal strength indicator, e.g., RSSI, of one or more broadcast signals received may be used to indicate which of the PAMs location information is more accurate. In another example, location information or a composite location value may be calculated based on multiple PAMs location information and weighted accordingly. For instance, particular PAMs or scanning angles therefrom that indicate stronger, e.g., closer or less interference, broadcast signals are utilized with a higher weighting value and others with lower quality or weaker broadcast signal strength would be provided a lower weighting value or be eliminated completely from the location information or composite location value, e.g., triangulation, calculation. In addition, by utilizing scanning PAMS, effect of reflection may be minimized because one or more scan angles may indicate echos or reflection free path, which reflection path values, for instance, being discounted, or completely ignored in triangulation calculations and a substantially reflection free path utilized in triangulation calculations.

In one embodiment, multiple PAMS, e.g., PAMS 802, 804, 806, 807, may not having intersecting lines, for instance, for maximum signal strength, due to multipath effects, e.g., one or more echos or reflections. As such, a maximum signal strength indicator, e.g., RSSI, may indicate a direction that is false, e.g., not in the direction of the smart phone. Referring to FIG. 11, the intersection of the scanning beams of all the multiple PAMS may not intersect, e.g., PAM 807 maximum signal strength indicator direction does not intersect others of PAMS 802, 804, 806. Referring to FIG. 11, maximum signal strength indicator, e.g., RSSI, for PAM 807 falsely indicates object 827 instead of smart phone 828 as do other PAMs 802, 804, 806. In one example, PAM 807 signal strength information may be eliminated for determination of location information, relative distance, or route of the smart phone 828.

In one variant, in addition to or as a check of location information or composite location value, signal strength, e.g., RSSI, measurement of the smart phone by nearby data tags, e.g., data tags 839, 841, may be used to supplement the composite location information. Advantageously, PAMS 802, 804, 806, 807 and data tags 839, 841 may together provide information that may be averaged, compared, or weighted to improve location accuracy of the smart phone. As such, multi-element phased arrays signal strength, e.g., Wi-Fi and audio information, and data tag signal strength indicator, e.g., RSSI, are used to improve accuracy, route, relative distance of locating smart phone from one or more advertisements 824, 826 and/or consumer displays 831, 833 proximally located.

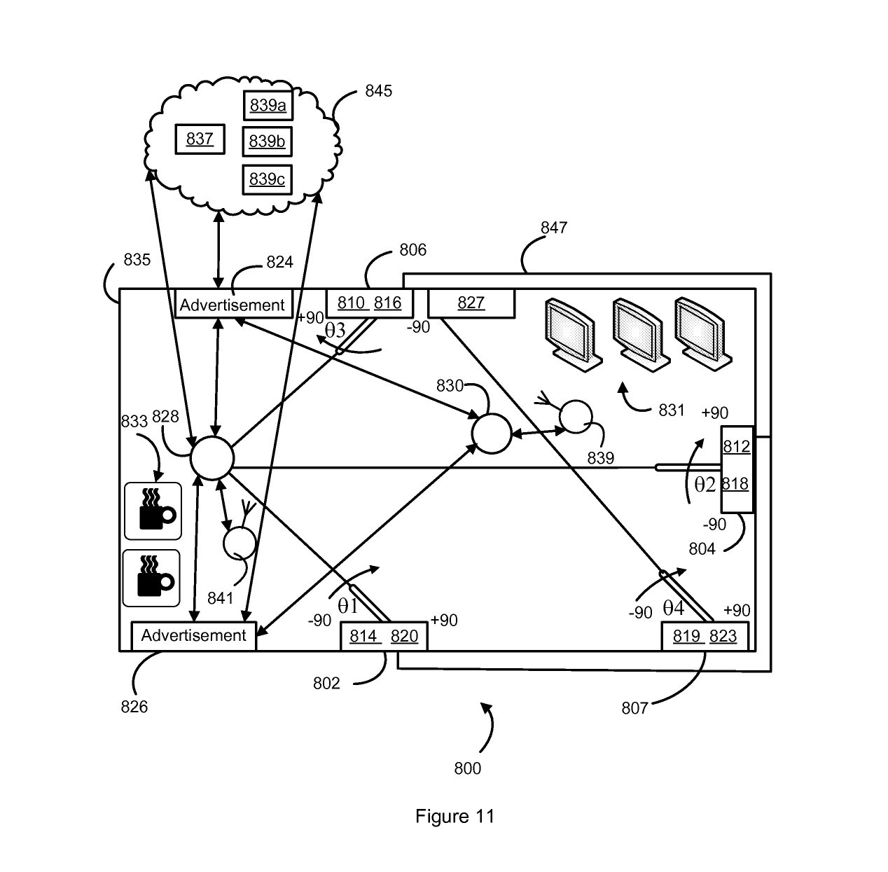

As further illustrated in FIGS. 11-16, ultrasound and Wi-Fi PAMs may be used by themselves, combined and used along or in alternating combinations with one another, e.g., every other PAM may include an ultrasound or a Wi-Fi module, to determine a route of distancing objects and obtaining information about smart phones or other wireless communication devices within a room or location. For example, as illustrated in FIG. 15 from smart phone 828, PAMs 814, 820 scan at −45 degrees and receive a maximum signal level of 0 dBm, PAMs 812, 818 scan at 0 degrees and receive a maximum signal level of 0 dBm and return signal from ultrasound waves delay equivalent to 2 meters, PAMs 810, 816 scan at +45 degrees and receive a maximum signal level of −1 dBm and return signal from ultrasound waves delay equivalent to 2.5 meters, and PAMs 819, 823 scan at −45 degrees and receive a maximum signal level of −3 dBm and return signal from ultrasound waves delay equivalent to 1.5 meters.

In one variant, a Data Base and Location Based Information Delivery are disclosed. In this variant, location based information is delivered to the RT devices such as smart phones. The RT device or the PAMs use the triangulated location of the RT devices to deliver location based information to the RT devices. The RT devices can access and be pushed information from a database that may be in the cloud server, corporate or local computing devices.

Advantageously, the systems and apparatus of this disclosure are used to deliver location based information to the RT devices. For instance, the system can be used to deliver information to museum goers about particular pieces of art that are near them or to shoppers about products that are near them within a store. Furthermore, redundancy features of the system using the hardware and firmware, for example, external to or within the PAM, and use of ultrasound waves to triangulate the location including phased array methodologies. Furthermore, advantageously, this location redundancy acquisition system, e.g., as illustrated in FIGS. 11-19, provides improvements over conventional single distance calculation designs or circuit topologies. For example, using only Wi-Fi or ultrasound; thus, the disclosed system has the ability to determine more accurately location of a RT, e.g., smart phone, within a room, building or outside venue and the delivery of information based upon relative distance, route, or location information.

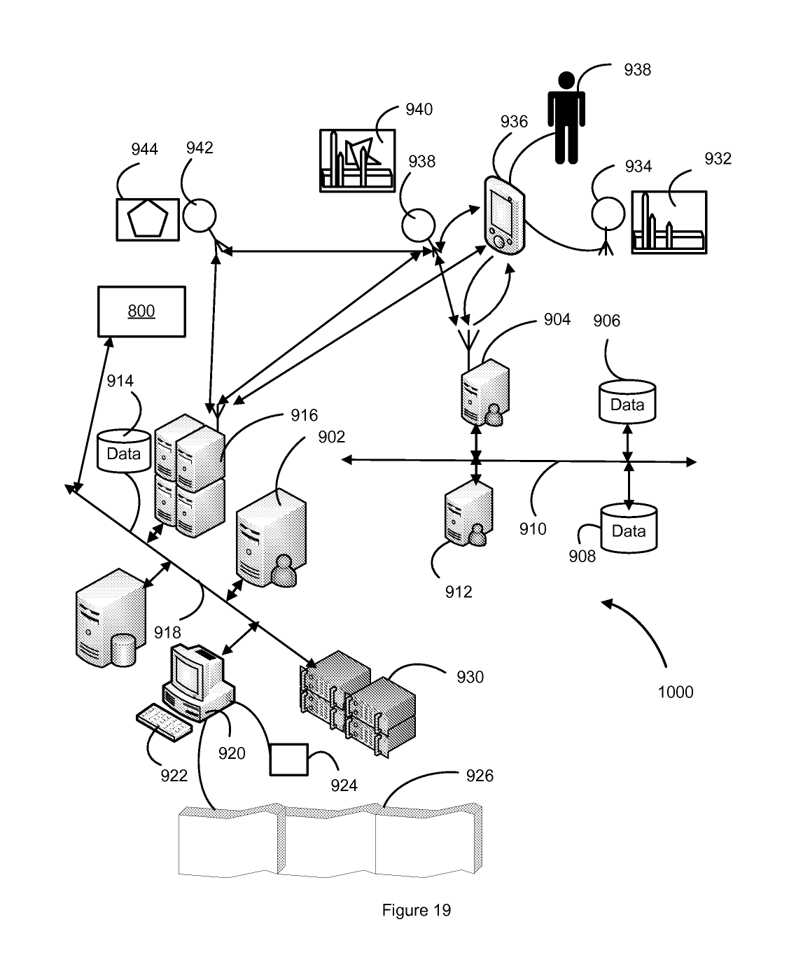

Referring to FIGS. 18 and 19, systems 900 and 100 disclose usage of location based system 800, disclosed in FIGS. 11-17, for locating wireless enabled devices that broadcast a signal within a distance and/or distance range of objects and/or data tags 839, 841, e.g., where individual functionality is illustrated in FIGS. 1-9, Table I associated text. For instance, systems 900 and 1000 communicates, for instance, using communications server 916 by wired bus 918 or wireless means, such as Bluetooth or Wi-Fi, connectivity with private and public databases, though communications server 904, 912 having wireless capability to access, for instance, information repository 906, 908 coupled to bus 910 and extracts information, e.g., RSSI, from a nearby smart phone 936, for instance, Smart Phone 1 and Smart Phone 2 illustrated in FIGS. 1-9 and associated text or in Table I.

Systems 900 and 1000 further includes data storage hardware device 914 capable of storage of user data, e.g., preferences, interests, “perspectives” in the information system, relative coordinates of smart phone 936 and/or user 938 using the smart phone 936 by relative distance to an object, e.g., painting 944, 940, 932 as illustrated in system 900, or Wi-Fi device or data tags 942, 938, 934 (see FIG. 19) associated with or closest to the object as illustrated in system 1000. For example, a particular item or location, e.g., as well as other information, for instance, relative location or distance from one or more of data tags 942, 938, 934 that are referenced, for instance, to an object 944, 938, 932 respectively or other components disclosed in FIGS. 1-9 and Table I on a temporary, transitory, or permanent basis. Application server 902 stores executable software program code, for instance, RSSI signal strength calculation or User Datagram Protocol (UDP) algorithms in a semi-transitory or non-transitory software media capable of transferability using communications server 916 to transmit wired or wirelessly from processor unit 924. For example, processor unit 924 communicatively coupled to computer 920 that has a keyboard 922 to allow, for instance, user 938 to provide remote inputs or direct inputs (if user is within range of keyboard 922).

As such, FIG. 19 is an exemplary system using one or more tags within the area obtain the signal strength indicator, e.g., RSSI, of the at least one wireless mobile device, In one instance, advertisement module configured to direct one or more advertisements 824, 826 to one or more tags 839, 841 based on preferences list 837. In one example, one or more tags 839, 841 are associated with consumer items of a particular type or groupings in a retailer shopping arena 835. In another variant, signal strength indicator, e.g., RSSI, includes a relative magnitude of a transmitted signal for each wireless mobile device within the area 835 (for instance illustrated in FIG. 11).

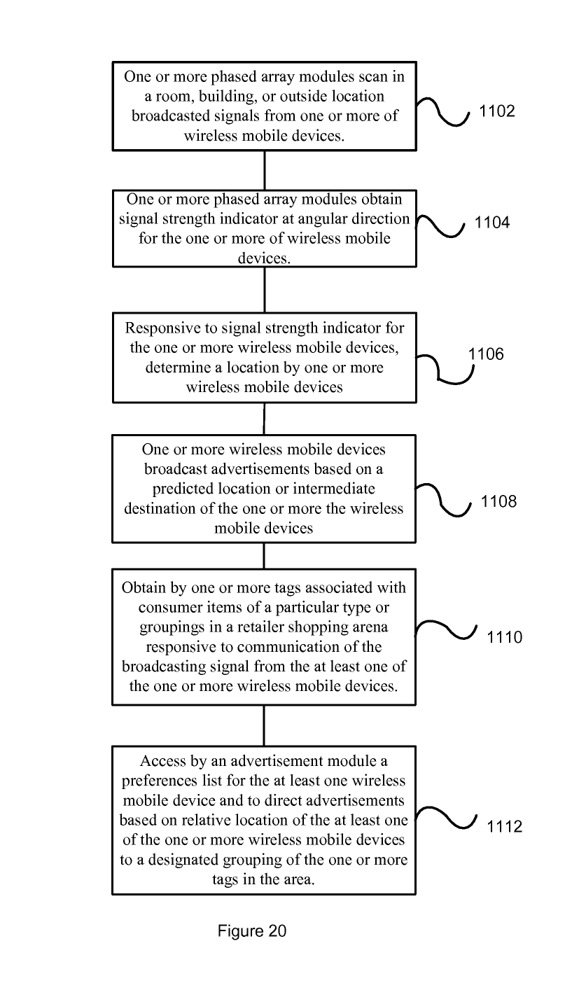

Referring to FIG. 20, method 1100 for location tracking is disclosed. In step 1102, one or more phased array modules scan in a room, building, or outside location broadcasted signals from a plurality of wireless mobile devices. In step 1104, one or more phased array modules obtain signal strength indicator, e.g., RSSI, at angular direction for one or more of wireless mobile devices. In step 1106, responsive to signal strength indicator for one or more wireless mobile devices, determine a location by one or more wireless mobile devices.

In step 1108, one or more wireless mobile devices broadcast advertisements based on a predicted location or intermediate destination or composite location information of the plurality of the wireless mobile devices. In one variant of the step 1108, averaging or weighting, eliminating, or supplementing beam path information from one or more PAMS or tags relative to the one or more wireless mobile devices to improve accuracy of composite location information. In one variant of the step 1108, accessing by an advertisement module a preferences list of the at least one of the plurality of wireless mobile devices 828, 830 and pushing advertisements 824, 826 based on the preferences list 837 for one or more wireless mobile devices based on the location, predicted location, or composite location information of each of the one or more wireless mobile devices. In another variant, wherein the scanning by the one or more phased array modules 802, 804, 806, 807 of the room, the building, or the outside location includes scanning using audio signals, radio waves or Wi-Fi signals.

In step 1110, obtaining by one or more tags 839, 841 associated with consumer items of a particular type or groupings 831, 833 in a retailer shopping arena 835 responsive to communication of the broadcasting signal from the at least one of the plurality of wireless mobile devices 828, 830. In one variant, the step of measuring the signal strength includes measuring a relative magnitude of the broadcasted signal and a scanning signal from the one or more phased array modules 802, 804, 806, 807 for each wireless mobile device to at least one of the one or more tags 839, 841 within the area 835.

In step 1112, accessing by an advertisement module 824, 826 a preferences list 837 for the at least one wireless mobile device 828, 830 and to direct advertisements 824, 826 based on relative location of the at least one of the wireless mobile device 828, 830 to a designated grouping of the one or more tags 839, 841 in the area 835.

In one variant of step 1112, accessing by an advertisement module 824, 826 a preferences list 837 for the at least of the one or more wireless mobile devices and to push advertisements based on objects proximal to and expected proximal to based on predicted routing of the at least one of the one or more wireless mobile devices 828, 830 within the room, the building, or the outside location.

In one variant of step 1102, forming and steering by a beam steering routine a highly directive signal beam from the one or more phased array 802, 804, 806, 807 to generate a listing of a group of wireless mobile devices 828, 830 having a directional pattern within a designated period at least partially based on relative distance from one or more groupings of the one or more tags 841, 839 and cross referenced with one or more preferences lists 837 from the group of wireless mobile devices 828, 830.

In one variant of step 1102, broadcasting a signal by the at least one of the plurality of wireless devices 828, 830 with the room, the building, or the outside location 835 includes broadcasting using an Adhoc network for sending messages between device location systems, a positioning and communications system, and the at least one of the plurality of wireless mobile devices 828, 830.

In summary, specific embodiments and applications of dynamic wireless networks and interactive wireless information communication and delivery systems have been disclosed. It should be apparent, however, to those skilled in the art that many more modifications besides those already described are possible without departing from the inventive concepts herein. The inventive subject matter, therefore, is not to be restricted except in the spirit of the disclosure herein. While the above detailed description has shown, described, and pointed out novel features of the invention as applied to various embodiments, it will be understood that various omissions, substitutions, and changes in the form and details of the device or process illustrated may be made by those skilled in the art without departing from the inventive concepts herein. Furthermore, the foregoing description includes the best mode presently of carrying out the inventive concepts and matters.

Moreover, in interpreting the disclosure, all terms and claims should be interpreted in the broadest possible manner consistent with the context. In particular, the terms “comprises”, “comprising”, “including”, and “includes” should be interpreted as referring to elements, components, or steps in a non-exclusive manner, indicating that the referenced elements, components, or steps may be present, or utilized, or combined with other elements, components, or steps that are not expressly referenced. This description of the embodiments disclosed is in no way meant to be limiting, but rather should be taken as illustrative of the general principles of the inventive concepts therein and one or more embodiments may be combined together and this combination is within scope of the present inventive concepts or matter. In addition, one skilled in the art would appreciate that elements of one or more embodiments, for instance, method steps for measuring relative signal strength disclosed in FIG. 9 or system disclosed in FIG. 10, may be combined together, rearranged, or eliminated to achieve still other embodiments that are within the teachings and scope of the present application.

We claim:

1. A location based system, the system comprising:
one or more phased array modules configured to scan to determine a signal strength indicator of a signal broadcasted from at least one wireless mobile device within a distance area, based on a signal strength indicator measured at multiple angular directions by the one or more phased array modules from the at least one wireless mobile device, a location of each wireless mobile device is determined within a room, building, or outside location.

2. The system of claim 1, wherein the one or more phased array modules configured to scan an area includes to scan an area using at least one of the following: audio signals, radio waves, or Wi-Fi signals.

3. The system of claim 1, further comprising software downloaded, upon user consent, on the at least one wireless mobile device to process at least one of the following: audio signals, radio waves, or Wi-Fi signals.

4. The system of claim 1, wherein the one or more phased array modules includes at least one of a Wi-Fi phased array or an ultrasound phased array.

5. The system of claim 1, further including an advertisement module configured to access a preferences list for the at least one wireless mobile device and to direct advertisements based on the location of the at least one of the wireless mobile device.

6. The system of claim 1, further including an advertisement module configured to direct advertisements based on the location of the at least one of the wireless mobile device.

7. The system of claim 1, further including a beam steering routine to form and steer a highly directive signal beam from the one or more phased array modules to generate a listing of a group of wireless mobile devices including the at least one wireless mobile device having a directional pattern within a designated period at least partially based on relative distance from one or more consumer product displays with the room, the building, or outside location.

8. The system of claim 7, further including an advertisement module configured to direct advertisements to a designated grouping of the group of wireless mobile devices in the location.

9. The system of claim 1, further comprising one or more tags within the area, the one or more tags obtain the signal strength indicator of the at least one wireless mobile device.

10. The system of claim 9, further including an advertisement module configured to direct advertisements to the one or more tags based on a preferences list.

11. The system of claim 9, wherein the one or more tags are associated with consumer items of a particular type or groupings in a retailer shopping arena.

12. The system of claim 1, wherein the signal strength indicator includes a relative magnitude of a transmitted signal for each wireless mobile device within the area.

13. A method for location tracking, the method comprising:
scanning by one or more phased array modules a room, building, or outside location having broadcasted signals from a plurality of wireless mobile devices;
obtaining a signal strength indicator at an angular direction by the one or more phased array modules for at least one of the plurality of wireless mobile devices; and
responsive to the signal strength indicator for the at least one of the plurality of wireless mobile devices, determining a location of at least one of the plurality of wireless mobile devices.

14. The method of claim 13, further comprising the step of broadcasting advertisements based on a predicted location or intermediate destination of the plurality of the wireless mobile devices.

15. The method of claim 13, further comprising the step of accessing by an advertisement module a preferences list of the at least one of the plurality of wireless mobile devices and pushing advertisements based on the preferences list for the at least one wireless mobile device based on the location of each of the at least one of the plurality of wireless mobile devices.

16. The method of claim 13, wherein the scanning by the one or more phased array modules of the room, the building, or the outside location includes scanning using audio signals, radio waves or Wi-Fi signals.

17. The method of claim 13, further comprising the step of obtaining by one or more tags associated with consumer items of a particular type or groupings in a retailer shopping arena responsive to communication of the broadcasting signal from the at least one of the plurality of wireless mobile devices.

18. The method of claim 13, wherein the step of measuring the signal strength includes measuring a relative magnitude of the broadcasted signal and a scanning signal from the one or more phased array modules for each wireless mobile device to at least one of the one or more tags within the area.

19. The method of claim 13, further including the step of accessing by an advertisement module a preferences list for the at least one wireless mobile device and to direct advertisements based on a relative location of the at least one of the wireless mobile device to a designated grouping of the one or more tags in the area.

20. The method of claim 13, further including the step of accessing by an advertisement module a preferences list for the at least of the plurality of wireless mobile devices and to push advertisements based on objects proximal to and expected proximal to based on predicted routing of the at least one of the plurality of wireless mobile devices within the room, the building, or the outside location.

21. The method of claim 13, further including the step of forming and steering by a beam steering routine a highly directive signal beam from the one or more phased array to generate a listing of a group of wireless mobile devices having a directional pattern within a designated period at least partially based on relative distance from one or more groupings of the one or more tags and cross referenced with one or more preferences lists from the group of wireless mobile devices.

22. The method of claim 21, further comprising the step of broadcasting a signal by the at least one of the plurality of wireless devices with the room, the building, or the outside location includes broadcasting using an Adhoc network for sending messages between device location systems, a positioning and communications system, and the at least one of the plurality of wireless mobile devices.
